(19) United States
(12) Patent Application Publication
(10) Pub. No.: US 2011/0131138 A1
(43) Pub. Date: Jun. 2, 2011

(54) COLLECTIVE SUSPENSION/SETTLEMENT REPRESENTATION PROCESSING SERVER DEVICE AND PROGRAM

(75) Inventor: Toshiko Tsuchiya, Yokohama (JP)

(73) Assignee: ICON CORP., Kanagawa (JP)

(21) Appl. No.: 13/057,463

(22) PCT Filed: Feb. 9, 2009
(86) PCT No.: PCT/JP2009/000517

§ 371 Date: Feb. 3, 2011

(30) Foreign Application Priority Data
Aug. 7, 2008 (JP) 2008-204894

(51) Int. Cl. H04L 9/32; G06Q 20/00; H04L 9/28

(52) U.S. Cl. 705/71; 713/168

(57) ABSTRACT

Provided is a collective suspension processing server device, collective suspension representation processing server device, settlement representation processing server device, method, and program, wherein there is no chance that the encryption key leaks. Also provided is the implementation of preventing the leakage of any piece of information under management. The collective suspension processing server device, collective suspension representation processing server device, settlement representation processing server device, method, and program does not hold the encryption key and the decryption key which are used to encrypt users' card information in a management database, but instead, dynamically generates the encryption key and the decryption key. Regarding the common key which is used in encryption, the common key is generated and encrypted for each authentication information table without destructing the rank order of strings of characters and numbers which constitute the authentication information, and encrypted strings of characters and numbers are searched using the common key generated and encrypted for each authentication information table. The decryption key which is used to decrypt the encrypted card information is unique to each user.

### BACKGROUND OF THE INVENTION

1. Field of the Invention

The present invention relates to a collective suspension processing server device, a collective suspension representation processing server device, a settlement representation processing server device, a method for a collective suspension processing, a method for a collective suspension representation processing, a method for a settlement representation processing and program.

2. Background Art

The users previously need to contact the monetary facilities and/or the credit card companies, and individually request them to perform the card suspension processing, when the users lose their ATM cards and/or credit cards. However, most users usually do not anticipate losing their credit cards etc., so they rarely record the predetermined card information etc. onto the paper or as an electric information. Moreover, the users do not always carry the record medium to which the card information are recorded, when the cards are lost. Consequently, the users tend to need long period of time to contact each contact point of the bank accounts and the credit cards, and so, there is a risk of other people using the cards before suspending all credit cards and bank accounts.

Furthermore, most users contract with plural monetary facilities, and so it is difficult for the individual to manage the contract information etc. of each monetary facilities. Therefore, the users may have forgotten the contract itself or the users may not notice the loss of the card. Therefore, the users come to realize that the settlement by his (her) card is performed by a third person, when they look at the bill for the purchase for the first time.

Incidentally, due to the development of the electronic commerce technique, the users can select their desired products on the network via the computer device and can get the actual products a few days later. So, for the users living outside the cities where the distribution is not developed and the users too busy to go out to stores, such electronic commercial system becomes absolutely essential for daily life and becomes normal tool or means.

However, when conducting electric commerce, the settlement processing are executed on the network, therefore the users will have a risk of leakage individual information such as card information. In addition, the users will have the risk of lightly purchasing the products which they do not hope, because the settlement processing are executed only by inputting the predetermined information to the operation screen of the computer device when purchasing the products.

There are plural patent documents which disclose the art for smoothly suspending the usage of the credit card etc. and processing the purchase of products while protecting the personal information.

According to the representative service disclosed in the patent document 1, the user's personal information, the information about the contents of the user's contracted service and so on are stored into the representation server after encryption. Therefore, the third person cannot know the user's personal information and the information about the content of the user's contracted services and so on. However, according to the system disclosed in the patent document 1, the manager of the representation server, who is the third person, needs to keep up the encryption key used for encrypting the user's personal information and the information about the content of the user's contracted services and so on, so, there is a risk that the encryption key may be stolen by the third person.

Moreover, according to the cyber settlement conservation device disclosed in the patent document 2, the authorization server decides whether the operator accords to the registered member using one-time password, and the business dealings can be done only when it is confirmed that the operator is identical to the registered member himself (herself). However, the decision is executed only by the accord of the one-time password without requesting the acceptance of the registered member himself (herself), so it is difficult to suppress the excessive consumption of card.

In addition, according to the settlement system disclosed in the patent document 3, the business dealings can be done by searching the database using the individual information such as telephone number in the wake of receiving the encrypted transaction code from the consumer, and by decrypting the transaction code using the searched decryption key corresponding to the encryption key provided to the consumer. However, according to the system described in the patent document 3, the decryption does not require the acceptance of the registered member, so it is difficult to suppress the excessive consumption of card.

Patent document 1: Japanese Laid Open Patent Application No. 2002-056198
Patent document 2: Japanese Laid Open Patent Application No. 2008-015924
Patent document 3: Japanese Laid Open Patent Application No. 2003-150885

### DISCLOSURE OF THE INVENTION

### Problems to be Solved by the Invention

As described above, the security of the conventional arts according to the representative service such as card suspension processing are weak, because the management of the encryption keys and the decryption keys used for the encryption of the individual information are inadequate. In the management method, the encryption keys are not managed by the owner of the individual information, and the encryption key manager has a risk that all user's information stored in the representation server will leak when the system administrator, who is a third person, leaks the encryption key data.

In recent years, there is a tendency to increase the number of cards used by single card user, so it becomes difficult to manage the contract information etc. of each card by the individual. Therefore, the cards cannot be suspended or cancelled expeditiously, and particularly, the procedures for the lost cards are not easy by the same reason even though the damages need to be minimized.

In addition, network user increases recently, and so the age range of the electric commerce user expands. As a result, the product can be purchased even by the old people not accustomed to the operation of the computer devices, the old people of dementia, the extravagant couples, the students without abilities to pay, and so the card crimes caused by the leaking of the individual information and the card bankrupts caused by purchasing going over the repayable amount become social problems.

It is an object of the present invention to provide a collective suspension processing server device, a collective suspension representation processing server device, a settlement representation processing server device, methods and programs which dissolve the risk to leak the individual information, even if the individual information is stolen, by making the owner of the individual information to manage the decryption key for decrypting the encrypted individual information, and which can prevent all information from leakage.

It is another object of the present invention to provide a collective suspension representation processing server device, method and program which encrypts and collectively manages the information corresponding to the cards of monetary facilities such as banks and credit card companies, and which executes the collective canceling and other kinds of procedures easily and speedily.

It is further object of the present invention to provide a settlement representation processing server device, method and program which previously prevent the involuntary electric commerce, the bank transfer scam and the phishing scam caused by executing the settlement based on the approval of the card owner, and which suppresses the card crimes and card bankrupts.

### Means to Solve the Problem

(1) It is an object of the present invention to solve the above mentioned problems. According to the first aspect of the present invention, there is provided a terminal device connected to the collective suspension processing server device, comprising:
a common key processing unit which generates a common encryption key used for encryption and a common decryption key used for decryption, by using an input unit which executes an input operation for inputting an electronic information based on a user's operation of the terminal device, a storage unit which stores the electronic information, a display unit which displays the electronic information, a reception unit which receives the electronic information, a user authorization information input from the input unit based on the user's input operation and a user identification information received from the storage unit,
a key generation processing unit which receives identification information stored in the storage unit in addition to the user authorization information input from the input unit based on the user's input operation and the monetary information corresponding to the information of the bank account and credit card owned by the user, and automatically generates a pair of the encryption key for encryption and the decryption key for decryption based on the monetary information, the authorization information and the identification information,
an encryption processing unit which receives letters and numerals used for an encryption from the common key processing unit when the user authorization information for registration is input from the input unit, generates the encrypted sequence of letters and numerals so that the order of source sequence is not mixed up and the number of letters and numerals is equal to or less than quintuple of the source sequence by putting letters and numerals of common encryption key into a sequence of letters and numerals of the user authorization information, acquire the user identification information from the storage unit of the terminal device, and generates the encrypted sequence of letters and numerals so that the order of source sequence is not mixed up and the number of letters and numerals is equal to or less than quintuple of the source sequence by putting letters and numerals of common encryption key into a sequence of letters and numerals of the user identification information,
a storage unit which stores the encrypted authorization information and the encrypted identification information generated by the encryption processing unit of the terminal device, a decryption common key information for decrypting the encrypted authorization information and the encrypted identification information, the decryption key generated by the key generation processing unit, the encrypted monetary information, the encrypted authorization information and the encrypted identification information with relating each other,
a transmission unit which transmits a decryption common key information for decrypting the encrypted authorization information and the encrypted identification information stored in the storage unit of the terminal device, the decryption key generated by the key generation processing unit, the encrypted monetary information, encrypted authorization information and the encrypted identification information,
a storage unit which stores an electronic information transmitted from the terminal device to the collective suspension processing server device,
a decryption processing unit which reads the encrypted monetary information and the decryption key stored in the storage unit of the terminal device, and decrypts the monetary information,
a reception unit which receives the decryption common key information for decrypting the encrypted authorization information and the encrypted identification information related to the selected monetary information, the decryption key generated by the key generation processing unit, the encrypted monetary information, the encrypted authorization information and the encrypted identification information, when the monetary information desired to be suspended is selected from among the decrypted monetary information displayed on the display unit of the terminal device, and the decryption common key information, the decryption key, the encrypted monetary information, the encrypted authorization information and the encrypted identification information are acquired from the storage unit and sent to the collective suspension processing server device,
an authorization unit which confirms whether the received encrypted authorization information is registered,
an encryption processing unit which checks the existence or nonexistence of an information completely identical to the encrypted sequence of letters and numerals of the encrypted authorization information and the encrypted identification information registered in the storage unit of the collective suspension processing server device, based on the encrypted sequence of letters and numerals of the encrypted authorization information and the encrypted identification information received from the terminal device,
a decryption processing unit which decrypts the encrypted authorization information and the encrypted identification information completely identical to the encrypted sequence of letters and numerals, the encrypted monetary information received from the terminal device, the decryption key for decryption, by using the decryption common key,
a transmission unit which transmits a monetary information outgoing command for suspension to the specified monetary facilities received from the terminal device.

(2) According to the first aspect of the present invention, there is provided a collective suspension processing method of a terminal device connected to the collective suspension processing server device, comprising:
a common key processing step which generates a common encryption key used for encryption and a common decryption key used for decryption, by using an input unit which executes an input operation for inputting an electronic information based on a user's operation of the terminal device, a storage unit which stores the electronic information, a display unit which displays the electronic information, a reception unit which receives the electronic information, a user authorization information input from the input unit based on the user's input operation and a user identification information received from the storage unit,
a key generation processing step which receives identification information for identifying the user stored in the storage unit in addition to the user authorization information input from the input unit based on the user's input operation and the monetary information corresponding to the information of the bank account and credit card owned by the user, and automatically generates a pair of the encryption key for encryption and the decryption key for decryption based on the monetary information, the authorization information and the identification information,
an encryption processing step which receives letters and numerals used for an encryption from the common key processing unit when the user authorization information for registration is input from the input unit, generates the encrypted sequence of letters and numerals so that the order of source sequence is not mixed up and the number of letters and numerals is equal to or less than quintuple of the source sequence by putting letters and numerals of common encryption key into a sequence of letters and numerals of the user authorization information, acquire the user identification information from the storage unit of the terminal device, and generates the encrypted sequence of letters and numerals so that the order of source sequence is not mixed up and the number of letters and numerals is equal to or less than quintuple of the source sequence by putting letters and numerals of common encryption key into a sequence of letters and numerals of the user identification information,
a storage step which stores the encrypted authorization information and the encrypted identification information generated by the encryption processing unit of the terminal device, a decryption common key information for decrypting the encrypted authorization information and the encrypted identification information, the decryption key generated by the key generation processing unit, the encrypted monetary information, the encrypted authorization information and the encrypted identification information with relating each other,
a transmission step which transmits a decryption common key information for decrypting the encrypted authorization information and the encrypted identification information stored in the storage unit of the terminal device, the decryption key generated by the key generation processing unit, the encrypted monetary information, encrypted authorization information and the encrypted identification information,
a storage step which stores an electronic information transmitted from the terminal device to the collective suspension processing server device,
a decryption processing step which reads the encrypted monetary information and the decryption key stored in the storage unit of the terminal device, and decrypts the monetary information,
a receiving step which receives the decryption common key information for decrypting the encrypted authorization information and the encrypted identification information related to the selected monetary information, the decryption key generated by the key generation processing unit, the encrypted monetary information, the encrypted authorization information and the encrypted identification information, when the monetary information desired to be suspended is selected from among the decrypted monetary information displayed on the display unit of the terminal device, and the decryption common key information, the decryption key, the encrypted monetary information, the encrypted authorization information and the encrypted identification information are acquired from the storage unit and sent to the collective suspension processing server device,
an authorization step which confirms whether the received encrypted authorization information is registered,
an encryption processing step which checks the existence or nonexistence of an information completely identical to the encrypted sequence of letters and numerals of the encrypted authorization information and the encrypted identification information registered in the storage unit of the collective suspension processing server device, based on the encrypted sequence of letters and numerals of the encrypted authorization information and the encrypted identification information received from the terminal device,
a decryption processing step which decrypts the encrypted authorization information and the encrypted identification information completely identical to the encrypted sequence of letters and numerals, the encrypted monetary information received from the terminal device, and the decryption key for decryption, by using the decryption common key,
a transmission step which transmits a monetary information outgoing command for suspension to the specified monetary facilities received from the terminal device.

(3) In the above mentioned first aspects of the present invention, it is preferable that the monetary account suspension processing system comprises:
the collective suspension representation processing server device according to claim 1,
a monetary facility server device which executes a processing for receiving an information related to the user, an encrypted monetary information for suspension and the decryption key from the terminal device, and for suspending an usage of the encrypted monetary information.

In the above mentioned first aspects of the present invention, it is preferable that the collective suspension processing server device, comprising a monetary facility server device for suspending an usage of the encrypted monetary information.

(4) According to the second aspect of the present invention, there is provided a server device connected to a terminal device via a network, comprising:
a common key processing unit which acquires a user authorization information and a user monetary information for registration input by a user's input operation from an input unit of the terminal device, and an identification information for identifying a user stored in the storage unit of the terminal device, and provides letters and numerals used for an encryption of the user authorization information and the user identification information, those are sent from a transmission unit of the terminal device and received by the collective suspension representation processing server device, by each field unit,
an encryption unit which generates an encrypted authorization information and an encrypted identification information, each of information has an encrypted sequence of letters and numerals so that the order of source sequence is not mixed up and the number of letters and numerals is equal to or less than quintuple of the source sequence by putting letters and numerals of common encryption key into a sequence of letters and numerals of the information,
a key generation processing unit which dynamically generates a first key using the encrypted authorization information and the encrypted identification information encrypted by the encryption processing unit, dynamically generates a second key using a random numerals and letters received from the key generation processing unit of the collective suspension representation processing server device, dynamically generates a third key using the first and second keys and generates an encrypted monetary information for settlement processing using the user monetary information and the third key,
a transmission unit which transmits the second key and the encrypted monetary information for settlement processing generated by the key generation processing unit from the transmission unit of the collective suspension representation processing server device to the terminal device,
a storage unit of the terminal device which stores a received information,
a decryption processing unit which;
   acquires the monetary information for encryption processing, the authorization information and the identification information to be suspended based on a monetary information outgoing command operation corresponding to suspension using a display unit of the terminal device, sending them from a transmission unit of the terminal device,
   generates an encrypted sequence of letters and numerals so that the order of source sequence is not mixed up and the number of letters and numerals is equal to or less than quintuple of the source sequence by putting letters and numerals for encrypting by each field unit into a sequence of letters and numerals of the information by the encryption processing unit of the collective suspension representation processing server device,
   generates a first key for reading out and decrypting the encrypted authorization information and the encrypted identification information completely identical to the encrypted sequence of letters and numerals of the encrypted authorization and the encrypted identification information stored in the storage unit, and
   decrypts an encrypted authorization information and an encrypted identification information,
a key generation processing unit which generates a third key using a first key generated by the decryption processing unit for decryption and a second key sent from the terminal device,
a decryption processing unit which decrypts an encrypted monetary information for settlement processing using the third key,
a transmission unit which transmits a monetary information outgoing command for suspension to the monetary facility.

(5) According to the second aspect of the present invention, there is provided a server device connected to a terminal device via a network, comprising:
a common key processing step which acquires a user authorization information and a user monetary information for registration input by a user's input operation from an input unit of the terminal device, an identification information for identifying a user stored in the storage unit of the terminal device, and provides letters and numerals used for an encryption of the user authorization information and the user identification information, those are sent from a transmission unit of the terminal device and received by the reception unit of the collective suspension representation processing server device, by each field unit,
an encryption step which generates an encrypted authorization information and an encrypted identification information, each of information has an encrypted sequence of letters and numerals so that the order of source sequence is not mixed up and the number of letters and numerals is equal to or less than quintuple of the source sequence by putting letters and numerals of common encryption key into a sequence of letters and numerals of the information,
a key generation processing step which dynamically generates a first key using the encrypted authorization information and the encrypted identification information encrypted by the encryption processing unit, dynamically generates a second key using a random numerals and letters received from the key generation processing unit of the collective suspension representation processing server device, dynamically generates a third key using the first and second keys and generates an encrypted monetary information for settlement processing using the user monetary information and the third key,
a transmission step which transmits the second key and the encrypted monetary information for settlement processing generated by the key generation processing unit from the transmission unit of the collective suspension representation processing server device to the terminal device,
a storage unit of the terminal device which stores a received information,
a decryption processing unit which;
   acquires the monetary information for encryption processing, the authorization information and the identification information to be suspended based on a monetary information outgoing command operation corresponding to suspension using a display unit of the terminal device, sending them from a transmission unit of the terminal device,
   generates an encrypted sequence of letters and numerals so that the order of source sequence is not mixed up and the number of letters and numerals is equal to or less than quintuple of the source sequence by putting letters and numerals for encrypting by each field unit into a sequence of letters and numerals of the information by the encryption processing unit of the collective suspension representation processing server device,
   generates a first key for reading out and decrypting the encrypted authorization information and the encrypted identification information completely identical to the encrypted sequence of letters and numerals of the encrypted authorization and the encrypted identification information stored in the storage unit, and
   decrypts an encrypted authorization information and an encrypted identification information,
a key generation processing step which generates a third key using a first key generated by the decryption processing unit for decryption and a second key sent from the terminal device,
a decryption processing step which decrypts an encrypted monetary information for settlement processing sent from the terminal device using the third key,
a transmission step which transmits a monetary information outgoing command for suspension to the monetary facility.

According to the third aspect of the present invention, there is provided a server device connected to a terminal device via a network, comprising:
a common key processing unit which acquires a user authorization information and a user credit card information for registration input from an input unit of the terminal device based on a user's input operation, an identification information for identifying the user, the authorization information and the user credit card information stored in a storage unit of the terminal device, each information is sent from a transmission unit of the terminal device, and provides letters and numerals for encrypting the user authorization information and the user identification information received is the settlement representation processing server device by each field unit,
an encryption processing unit which generates an encrypted authorization information and an encrypted identification information, each of information has an encrypted sequence of letters and numerals so that the order of source sequence is not mixed up and the number of letters and numerals is equal to or less than quintuple of the source sequence by putting letters and numerals of common encryption key into a sequence of letters and numerals of the information,
a key generation processing unit which dynamically generates a first key using the encrypted authorization information and the encrypted identification information encrypted by the encryption processing unit, dynamically generates a second key using a random numerals and letters received from the key generation processing unit of the collective suspension representation processing server device, dynamically generates a third key using the first and second keys and generates an encrypted monetary information for settlement processing using the user credit card information and the third key,
a transmission unit which transmits the second key and the encrypted user credit card information for settlement processing generated by the key generation processing unit from the transmission unit of the collective suspension representation processing server device to the terminal device,
a storage unit of the terminal device which stores the received information,
a transmission unit which reads out the user authorization information, the user identification information and the user credit card information, and transmits them to the reception unit of the settlement representation processing server, when an operation for requesting a product desired to be purchased is executing using the input unit of the terminal device,
a decryption processing unit which;
   being provided with letters and numerals for encrypting a user authorization information and a user identification information received by the reception unit of the settlement representation processing server device by each field unit,
   searches information from among the encrypted authorization information and the encrypted identification information stored as the information for registration in the storage unit of the settlement representation processing server device, the searched information are completely identical to the encrypted authorization information and the encrypted identification information generated by an encryption processing unit,
   decrypts only an electronic mail address contained in the encrypted authorization information stored by each field unit and makes a transmission unit to send a settlement execution processing confirmation notification toward the decrypted electronic mail address,
   makes a display unit of the terminal device to display the settlement execution processing confirmation notification received by a reception unit of the terminal device,
   makes the terminal device to acquire an encrypted credit card information for settlement processing, an authorization information, an identification information and a second key from the storage unit of the terminal device and send them using a transmission unit of the terminal device, when a confirming processing request operation is executed based on the contents displayed on the display unit,
   makes the encryption processing unit to generate encrypted sequences of letters and numerals so that the order of source sequence is not mixed up and the number of letters and numerals is equal to or less than quintuple of the source sequence by putting letters and numerals for encrypting by each field unit into a sequence of letters and numerals of the user authorization information and the user identification information received by the settlement representation processing server device,
   reads out the encrypted authorization information and the encrypted identification information completely identical to the encrypted sequence of letters and numerals of the encrypted authorization information and the encrypted identification information stored in the storage unit, and generates a first key for decryption,
a key generation processing unit which generates a third key using a first key generated by the decryption processing unit for decryption and a second key sent from the terminal device,
a decryption processing unit which decrypts the encrypted credit card information for settlement processing sent from the terminal device using the third key,
a transmission unit which transmits the credit card information to a monetary facility to execute a settlement processing with a monetary information.

According to the third aspect of the present invention, there is provided a settlement representation processing method using server device connected to a terminal device via a network, comprising:
a common key processing step which acquires a user authorization information and a user credit card information for registration input from an input unit of the terminal device based on a user's input operation, an identification information for identifying the user authorization information and the user credit card information stored in a storage unit of the terminal device, each information is sent from a transmission unit of the terminal device, and provides letters and numerals for encrypting the user authorization information and the user identification information received by the reception unit of the settlement representation processing server device by each field unit,
an encryption processing step which generates an encrypted authorization information and an encrypted identification information, each of information has an encrypted sequence of letters and numerals that the order of source sequence is not mixed up and the number of letters and numerals is equal to or less than quintuple of the source sequence by putting letters and numerals of common encryption key into a sequence of letters and numerals of the information,

a key generation processing step which dynamically generates a first key using the encrypted authorization information and the encrypted identification information encrypted by the encryption processing unit, dynamically generates a second key using a random numerals and letters received from the key generation processing unit of the collective suspension representation processing server device, dynamically generates a third key using the first and second keys and generates an encrypted credit card information for settlement processing using the user credit card information and the third key,
a transmission step which transmits the second key and the encrypted credit card information for settlement processing generated by the key generation processing unit from the transmission unit of the collective suspension representation processing server device to the terminal device,
a storage step of the terminal device which stores the received information,
a transmission step which reads out the user authorization information and the user identification information and the user credit card information, and transmits them to the reception unit of the settlement representation processing server, when an operation for requesting a product desired to be purchased is executed using the input unit of the terminal device,
a decryption processing step which;
   being provided with letters and numerals for encrypting a user authorization information and a user identification information received by the reception unit of the settlement representation processing server device by each field unit,
   searches information from among the encrypted authorization information and the encrypted identification information stored as the information for registration in the storage unit of the settlement representation processing server device, the searched information are completely identical to the encrypted authorization information and the encrypted identification information generated by an encryption processing unit,
   decrypts only an electronic mail address contained in the encrypted authorization information stored by each field unit and makes a transmission unit to send a settlement execution processing confirmation notification toward the decrypted electronic mail address,
   makes a display unit of the terminal device to display the settlement execution processing confirmation notification received by a reception unit of the terminal device,
   makes the terminal device to acquire an encrypted credit card information for settlement processing, an authorization information, an identification information and a second key from the storage unit of the terminal device and send them using a transmission unit of the terminal device, when a confirming processing request operation is executed based on the contents displayed on the display unit,
   makes the encryption processing unit to generate encrypted sequences of letters and numerals so that the order of source sequence is not mixed up and the number of letters and numerals is equal to or less than quintuple of the source sequence by putting letters and numerals for encrypting by each field unit into a sequence of letters and numerals of the user authorization information and the user identification information received by the settlement representation processing server device,
   reads out the encrypted authorization information and the encrypted identification information completely identical to the encrypted sequence of letters and numerals of the encrypted authorization information and the encrypted identification information stored in the storage unit, and generates a first key for decryption,
a key generation processing step which generates a third key using a first key generated by the decryption processing unit for decryption and a second key sent from the terminal device,
a decryption processing step which decrypts the encrypted credit card information for settlement processing sent from the terminal device using the third key,
a transmission step which transmits the credit card information to a monetary facility to execute a settlement processing with a monetary information.

In the above mentioned third aspects of the present invention, it is preferable that the monetary facility settlement processing system comprises a server device which receives the settlement request processing information, the decryption key, the identification information and the authorization information from the terminal device and executes a settlement request processing.

According to the fourth aspect of the present invention, there is provided a settlement request information providing device in which a terminal device and a settlement representation processing server device are connected via Internet, comprising:
a reception unit which receives a user authorization information and a user credit card information for registration input from an input unit of the terminal device based on a user's input operation, an identification information for identifying the user stored in a storage unit of the terminal device, transmitted from a transmission unit toward the settlement representation processing server device,
a common key processing unit which provides letters and numerals for encrypting the user authorization information, user identification information and the credit card information received by the reception unit, by each field unit,
an encryption processing unit which generates an encrypted authorization information, an encrypted identification information and an encrypted credit card information, each of information has an encrypted sequence of letters and numerals that the order of source sequence is not mixed up and the number of letters and numerals is equal to or less than quintuple of the source sequence, by putting letters and numerals of common encryption key into a sequence of letters and numerals of the information,
an encryption processing unit which makes the common key processing unit to generate letters and numerals for encrypting the credit card information and the authorization information by each field unit, and dynamically generates encrypted sequence of letters and numerals of an encrypted credit card information and an encrypted authorization information so that the order of source sequence is not mixed up and the number of letters and numerals is equal to or less than quintuple of the source sequence, by putting the letters and numerals into the credit card information and the authorization information contained in a settlement request information when the settlement processing server device is provided with a settlement processing request information for settling the product using credit card from a product settlement information providing device of external.
a control processing unit which checks whether the encrypted credit card information stored in the storage unit of the settlement representation processing server device and the encrypted sequence of letters and numerals of the encrypted authorization information are completely identical, and stop a processing if they are not identical,
a transmission unit which transmits a settlement processing suspension command to the product settlement request information providing device of external.

According to the fourth aspect of the present invention, there is provided a settlement request information providing method of a device in which a terminal device and a settlement representation processing server device are connected via Internet, comprising:
a receiving step which receives a user authorization information and a user credit card information for registration input from an input unit of the terminal device based on a user's input operation, an identification information for identifying the user stored in a storage unit of the terminal device, transmitted from a transmission unit toward the settlement representation processing server device,
a common key processing step which provides letters and numerals for encrypting the user authorization information, user identification information and the credit card information received by the reception unit, by each field unit,
an encryption processing step which generates an encrypted authorization information, an encrypted identification information and an encrypted credit card information, each of information has an encrypted sequence of letters and numerals that the order of source sequence is not mixed up and the number of letters and numerals is equal to or less than quintuple of the source sequence, by putting letters and numerals of common encryption key into a sequence of letters and numerals of the information,
an encryption processing step which makes the common key processing unit to generate letters and numerals for encrypting the credit card information and the authorization information by each field unit, and dynamically generates encrypted sequence of letters and numerals of an encrypted credit card information and an encrypted authorization information so that the order of source sequence is not mixed up and the number of letters and numerals is equal to or less than quintuple of the source sequence, by putting the letters and numerals into the credit card information and the authorization information contained in a settlement request information when the settlement processing server device is provided with a settlement processing request information for settling the product using credit card from a product settlement information providing device of external.
a control processing step which checks whether the encrypted credit card information stored in the storage unit of the settlement representation processing server device and the encrypted sequence of letters and numerals of the encrypted authorization information are completely identical, and stops the processing if they are not identical,
a transmission step which transmits a settlement processing suspension command to the product settlement request information providing device of external.

According to the fifth aspect of the present invention, there is provided a collective suspension processing server device connected to a terminal device, wherein:
the collective suspension processing server device is connected to the terminal device comprising;
an input unit which executes an input operation for inputting an electronic information based on a user's operation of the terminal device,
a storage unit which stores the electronic information,
a display unit which displays the electronic information,
a reception unit which receives the electronic information,
a common key processing unit which generates an encryption key information,
a key generation processing unit which receives identification information stored in the storage unit in addition to the user authorization information input from the input unit based on the user's input operation and the monetary information corresponding to the information of the bank account and credit card owned by the user, automatically generates a pair of the encryption key for encryption and the decryption key for decryption based on the monetary information, the authorization information and the identification information, and automatically generates a user monetary information encrypted using the encryption key when the user monetary information for registration is input from the input unit,
an encryption processing unit which generates an encryption key for encryption when the user authorization information for registration is input from the input unit, generates the encrypted sequence of letters and numerals so that the order of source sequence is not mixed up and the number of letters and numerals is equal to or less than quintuple of the source sequence by putting the encryption key into a sequence of letters and numerals of the user authorization information, acquires the user identification information from the storage unit of the terminal device, and generates the encrypted sequence of letters and numerals so that the order of source sequence is not mixed up and the number of letters and numerals is equal to or less than quintuple of the source sequence by putting the encryption key into a sequence of letters and numerals of the user identification information, and
the collective suspension processing server device comprises:
a reception unit which receives the common key information having a pair of the encryption key and the decryption key generated by the common key processing unit of the terminal device, the encrypted authorization information and the encrypted identification information generated by the common key processing unit and the encrypted monetary information generated by the key generation unit of the terminal device, each of which is sent by a transmission unit of the terminal device,
a storage unit which;
   receives a common key information containing a pair of an encryption key information and a decryption key, in which the encryption key information is generated by encrypting the encrypted identification information, the encrypted authorization information and the encrypted identification information, and the decryption key is used for decrypting them, and receives an encrypted monetary information generated in the key generation processing unit of the terminal device,
   stores the encrypted authorization information, the encrypted identification information and the common key information, which are encrypted and sent from the transmission unit of the terminal device, with relating each other,
a decryption processing unit which;
   reads out a specified decryption key for decrypting the monetary information desired to be suspended, the encrypted authorization information and the encrypted identification information encrypted by the common key processing unit and stored in it, when a monetary information outgoing command for suspension is selected and an operation is executed using a display unit of the terminal device,
   makes the transmission unit of the terminal device to send the information,
   reads out the encrypted authorization information and the encrypted identification information having letters and numerals completely identical to those of the encrypted authorization information and the encrypted identification information received from the terminal device, from the storage unit,
   decrypts the encrypted monetary information using the decryption key that is prepared for decrypting the encrypted monetary information, and
a transmission unit which transmits a monetary information outgoing command for suspension to the monetary facility.

According to the fifth aspect of the present invention, there is provided a collective suspension processing method, wherein:
a step of connecting a server device to a terminal device which executes;
   a key generation processing step which receives identification information for identifying the user stored in the storage unit in addition to the user authorization information input from the input unit based on the user's input operation and the monetary information corresponding to the information of the bank account and credit card owned by the user, automatically generates a pair of the encryption key for encryption and the decryption key for decryption based on the monetary information, the authorization information and the identification information, and automatically generates a user monetary information encrypted using the encryption key when the user monetary information for registration is input from the input unit,
   an encryption processing step which generates an encryption key for encryption when the user authorization information for registration is input from the input unit, generates the encrypted sequence of letters and numerals so that the order of source sequence is not mixed up and the number of letters and numerals is equal to or less than quintuple of the source sequence by putting the encryption key into a sequence of letters and numerals of the user authorization information, acquires the user identification information from the storage unit of the terminal device, and generates the encrypted sequence of letters and numerals so that the order of source sequence is not mixed up and the number of letters and numerals is equal to or less than quintuple of the source sequence by putting the encryption key into a sequence of letters and numerals of the user identification information, and
a receiving step which receives the common key information having a pair of the encryption key and the decryption key generated by the common key processing unit of the terminal device, the encrypted authorization information and the encrypted monetary information generated by the common key processing unit and the encrypted monetary information generated by the key generation unit of the terminal device, each of which is sent by a transmission unit of the terminal device,
a storage step which;
   receives a common key information containing a pair of an encryption key information and a decryption key, in which the encryption key information is generated by encrypting the encrypted identification information, the encrypted authorization information and the encrypted identification information, and the decryption key is used for decrypting the encryption key, and receives an encrypted monetary information generated in the key generation processing unit of the terminal device,
   stores the encrypted authorization information, the encrypted identification information and the common key information, which are encrypted and sent from the transmission unit of the terminal device, with relating each other,
a decryption processing step which;
   reads out a specified decryption key for decrypting the monetary information desired to be suspended, the encrypted authorization information and the encrypted identification information encrypted by the common key processing unit and stored in it, when a monetary information outgoing command for suspension is selected and an operation is executed using a display unit of the terminal device,
   makes the transmission step of the terminal device to send the information,
   reads out the encrypted authorization information and the encrypted identification information having letters and numerals completely identical to those of the encrypted authorization information and the encrypted identification information received from the terminal device, from the storage unit,
   decrypts the encrypted monetary information using the decryption key that is prepared for decrypting the encrypted monetary information
a transmission unit which transmits a monetary information outgoing command for suspension to a monetary facility.

According to the sixth aspect of the present invention, there is provided a collective suspension representation processing server device connected to a terminal device, comprising:
an encryption processing unit which acquires a user authorization information and a user monetary information for registration input from an input unit of the terminal device based on a user's input operation, an identification information for identifying the user stored in a storage unit of the terminal device, makes a transmission unit of the terminal device to transmit the information, generates an encryption key for encrypting the received user authorization information and user identification information, generates the encrypted sequence of letters and numerals so that the order of source sequence is not mixed up and the number of letters and numerals is equal to or less than quintuple of the source sequence by putting the encryption key into a sequence of letters and numerals of the user identification information,
a key generation processing unit which dynamically generates a first encryption key using the user authorization information sent from the transmission unit of the terminal device, dynamically generates a second encryption key using the user identification information, dynamically generates a third encryption key using the first and second keys and generates an encrypted monetary information using the user monetary information and the third encryption key,
a decryption processing unit which;
   makes the key generation processing unit to dynamically generates a decryption key for decrypting the first encryption key,
   makes a transmission unit to transmit the decryption key to the terminal device,
   makes the terminal device to acquire the decryption key for the monetary information desired to be suspended, the authorization information and the identification information from the storage unit of the terminal device by operating the monetary information outgoing command for suspension using the display unit, and to send the information from the terminal,
   makes an encryption processing unit to generate the encrypted sequence of letters and numerals so that the order of source sequence is not mixed up and the number of letters and numerals is equal to or less than quintuple of the source sequence by putting the common encryption key into a sequence of letters and numerals of the information,
   reads out the encrypted authorization information and the encrypted identification information completely identical to the sequence of letters and numerals, from among the sequences of letters and numerals of the encrypted authorization information and the encrypted identification information stored in the storage unit,
   decrypts the encrypted monetary information stored with relating to the encrypted authorization information and the encrypted identification information in the storage unit, using a decryption key sent from the key generation processing unit with the monetary information outgoing command for suspension,
a transmission unit transmits the monetary information outgoing command for suspension to a monetary facility.

According to the sixth aspect of the present invention, there is provided a collective suspension representation processing method of a device connected to a terminal device, comprising:
an encryption processing step which acquires a user authorization information and a user monetary information for registration input from an input unit of the terminal device based on a user's input operation, an identification information for identifying the user stored in a storage unit of the terminal device, makes a transmission unit of the terminal device to transmit the information, generates an encryption key for encrypting the received user authorization information and user identification information, generates the encrypted sequence of letters and numerals so that the order of source sequence is not mixed up and the number of letters and numerals is equal to or less than quintuple of the source sequence by putting the encryption key into a sequence of letters and numerals of the user identification information,
a key generation processing step which dynamically generates a first encryption key using the user authorization information sent from the transmission unit of the terminal device, dynamically generates a second encryption key using the user identification information, dynamically generates a third encryption key using the first and second keys and generates an encrypted monetary information using the user monetary information and the third encryption key,
a decryption processing step which;
   makes the key generation processing unit to dynamically generate a decryption key for decrypting the first encryption key,
   makes a transmission unit to transmit the decryption key to the terminal device,
   makes the terminal device to acquire the decryption key for the monetary information desired to be suspended, the authorization information and the identification information from the storage unit of the terminal device by operating the monetary information outgoing command for suspension using the display unit, and to send the information from the terminal device,
   makes an encryption processing unit to generate the encrypted sequence of letters and numerals so that the order of source sequence is not mixed up and the number of letters and numerals is equal to or less than quintuple of the source sequence by putting the common encryption key into a sequence of letters and numerals of the information,
   reads out the encrypted authorization information and the encrypted identification information completely identical to the sequence of letters and numerals, from among the sequences of letters and numerals of the encrypted authorization information and the encrypted identification information stored in the storage unit,
   decrypts the encrypted monetary information stored with relating to the encrypted authorization information and the encrypted identification information stored in the storage unit, using a decryption key sent from the key generation processing unit with the monetary information outgoing command for suspension,
a transmission step transmits the monetary information outgoing command for suspension to a monetary facility.

According to the seventh aspect of the present invention, there is provided a settlement representation processing server device connected to a network, and connected to a terminal device which is;
comprising an input unit which is operated to input an electronic information, a storage unit which stores the electronic information, a display unit which displays the electronic information, and a reception unit which receives the electronic information,
acquiring a user authorization information and a user credit card information for registration input from the input unit based on a user's input operation, and an identification information for identifying the user stored in the storage unit,
comprising a transmission unit which acquires the user authorization information and the user identification information from the storage unit and transmits them as the electronic information when the input unit is operated to order the product desired to be purchased,
wherein the settlement representation processing server device comprises;
a storage unit which stores the electronic information,
a reception unit which receives the electronic information,
an encryption processing unit for encrypting the electronic information, which generates an encrypted authorization information and an encrypted identification information, by encrypting the authorization information and the identification information, so that the order of source sequence of letters and numerals is not mixed up and the number of letters and numerals is equal to or less than quintuple of the source sequence by putting the common encryption key into a sequence of letters and numerals of the information,
a decryption processing unit which reads out the encrypted authorization information and the encrypted identification information completely identical to the encrypted sequence of letters and numerals of the encrypted authorization information, and decrypts the read information,
a transmission unit which transmits a settlement execution processing confirmation notification information, that is one of the decrypted authorization information, to the reception unit of the terminal device,
a key generation processing unit which;
   makes the storage unit of the terminal device to read out an information for registration, that is, the user authorization information, the user identification information and the decryption key,
   makes the transmission unit of the terminal device to transmit the contents displayed on the display unit of the terminal device and the information read out from the storage unit of the terminal device,
   makes the encryption processing unit to provide an encrypted authorization information, an encrypted identification information and the decryption key by encrypting the user authorization information, the user identification information and the decryption key received in the reception unit, and
wherein, the settlement representation processing server device reads out an encrypted monetary information stored in the storage unit, provides it to the key generation processing unit, decrypts the user information using the decryption key and transmits it to the monetary facility for executing a settlement processing with a monetary information corresponding to the settlement processing.

According to the seventh aspect of the present invention, there is provided a settlement representation processing method comprising;
an input step which is operated to input an electronic information, a storage unit which stores the electronic information, a display unit which displays the electronic information, and a reception unit which receives the electronic information,
an acquiring step which acquires a user authorization information and a user credit card information for registration input from the input unit based on a user's input operation, and an identification information for identifying the user stored in the storage unit,
a transmission step which acquires the user authorization information and the user identification information from the storage unit and transmits them as the electronic information when the input unit is operated to order the product desired to be purchased,
a storage step which stores the electronic information,
a receiving step which receives the electronic information,
an encryption processing step for encrypting electronic information which generates an encrypted authorization information and an encrypted identification information, by encrypting the authorization information and the identification information of the user received by the user receiving step, so that the order of source sequence of letters and numerals is not mixed up and the number of letters and numerals is equal to or less than quintuple of the source sequence by putting the common encryption key into a sequence of letters and numerals of the information,
a decryption processing step which reads out the encrypted authorization information and the encrypted identification information completely identical to the encrypted sequence of letters and numerals of the encrypted authorization information, and decrypts the read information,
a transmission step which transmits a settlement execution processing confirmation notification information, that is one of the decrypted authorization information, to the reception unit of the terminal device,
a key generation processing step which;
   makes the storage unit of the terminal device to read out an information for registration, that is, the user authorization information, the user identification information and the decryption key,
   makes the transmission unit of the terminal device to transmit the contents displayed on the display unit of the terminal device and the information read out from the storage unit of the terminal device,
   makes the encryption processing unit to provide an encrypted authorization information, an encrypted identification information and the decryption key by encrypting the user authorization information, the user identification information and the decryption key, and
wherein, the settlement representation processing server device reads out an encrypted monetary information stored in the storage unit, provides it to the key generation processing unit, decrypts the user information using the decryption key and transmits it to the monetary facility for executing a settlement processing with a monetary information corresponding to the settlement processing.

According to the eighth aspect of the present invention, there is provided a settlement system in which a terminal device and a settlement representation processing server device are connected, comprising;
an encryption processing unit which acquires a user authorization information and a user credit card information for registration input from an input unit of the terminal device based on the user's input operation and identification information for identifying the user stored in the storage unit of a terminal device, and dynamically generates an encrypted credit card information and an encrypted authorization information so that the order of source sequence is not mixed up and the number of letters and numerals is equal to or less than quintuple of the source sequence by putting the common encryption key for encryption into a sequence of letters and numerals of the credit card information and the authorization information contained in a settlement request information when the settlement representation processing server device is provided with a settlement processing request information for settling the product using credit card from a product settlement request information providing device of external,
a control processing unit which checks whether the encrypted credit card information and the encrypted authorization information are completely identical to an encrypted sequence of letters and numerals of the encrypted credit card information and the encrypted authorization information stored in a storage unit of the settlement representation processing server, and if they are not identical, the processing stops,
a transmission unit which transmits a settlement processing suspension command to the product settlement request information providing device of external.

According to the eighth aspect of the present invention, there is provided a settlement representation processing method of a system in which a terminal device and a settlement representation processing server device are connected, comprising;
an encryption processing step which acquires a user authorization information and a user credit card information for registration input from an input unit of the terminal device based on the user's input operation and identification information for identifying the ser stored in the storage unit of the terminal device, and dynamically generates an encrypted credit card information and an encrypted authorization information so that the order of source sequence is not mixed up and the number of letters and numerals is equal to or less than quintuple of the source sequence by putting the common encryption key for encryption into a sequence of letters and numerals of the credit card information and the authorization information contained in a settlement request information when the settlement representation processing server device is provided with a settlement processing request information for settling the product using credit card by a product settlement request information providing device of external,
a control processing step which checks whether the encrypted credit card information and the encrypted authorization information are completely identical to an encrypted sequence of letters and numerals of the encrypted credit card information and the encrypted authorization information stored in a storage unit of the settlement representation processing server and if they are not identical, the processing stops,
a transmission step which transmits a settlement processing suspension command to the product settlement request information providing device of external.

According to the ninth aspect of the present invention, there is provided a settlement processing server device, comprising a monetary facility server device which executes a credit card settlement.

According to the ninth aspect of the present invention, there is provided a settlement processing system comprising;
a transaction unit of the settlement representation processing server device which transmits the encrypted monetary information,
a monetary facility server device which receives the encrypted monetary information via the network,
a transmission unit of the user terminal device which transmits the second key for decrypting the encrypted monetary information and the encrypted monetary information for settlement processing directly to the monetary facility server device, and
a monetary facility server device which executes the settlement processing.

### EFFECT OF THE PRESENT INVENTION

The present invention collectively suspends the cards of the plural different monetary facilities and credit card companies using the collective suspension processing server device or the collective suspension representation processing server device, so can reduce the work of the user. In addition, the collective suspension processing server device or the collective suspension representation processing server device of the present invention encrypts the card information of the user using the third key automatically generated by the first and second key. Therefore, the security of the encryption key itself can be enhanced. Moreover, the second key used for the generation of the third key is not kept by the management database but kept by each user, and so, it can be prevented that the card information of all users leak at once. Furthermore, according to the present invention, the second keys used for the decryption of the encrypted information differ by each user, and so, the intensity of the encrypted information can be enhanced.

### BRIEF DESCRIPTION OF THE DRAWINGS

FIG. 1 is a diagram showing a structure of a collective suspension processing system (that is, a collective suspension representation processing system) according to an embodiment of the present invention.

FIG. 2 is a diagram showing a structure of a table to store user identification information according to an embodiment of the present invention.

FIG. 3A is a diagram showing a structure of a table to store user authorization information according to an embodiment of the present invention.

FIG. 3B is a diagram showing an example of a table of a server device to store a received information as an encrypted data which is encrypted using a common key generated dynamically by each field unit.

FIG. 4A is a diagram showing a processing to encrypt and decrypt a user identification information and a user authorization information according to an embodiment.

FIG. 4B is a diagram showing a processing to encrypt a user monetary information according to an embodiment.

FIG. 4C is a diagram showing a processing to decrypt a user identification information and a user authorization information according to an embodiment.

FIG. 4D is a diagram showing a processing of a kept key generation processing unit (not shown in Figures) in the user terminal device 10 according to the present embodiment.

FIG. 4E is a diagram showing a processing of an encryption processing unit (not shown in Figures) in a collective suspension representation processing server device 20 according to the present embodiment.

FIG. 4F is a diagram showing a processing of a decryption processing unit (not shown in Figures) in a collective suspension representation processing server device 20 according to the present embodiment.

FIG. 5 is a sequence diagram showing a procedure of a service registration according to the present embodiment.

FIG. 6 is a sequence diagram showing a procedure for requesting a suspension processing according to the present embodiment.

FIG. 7 is a diagram showing an example of an execution authorization screen displayed by a user terminal device 10 based on a processing of step S116 by a collective suspension processing server device 20 (i.e. a collective suspension representation processing server device) according to the present embodiment.

FIG. 8 shows a construction of a settlement system 100 according to another embodiment of the present invention.

FIG. 9 is a block diagram showing a construction of a terminal device 10a of a settlement system according to the present embodiment.

FIG. 10 is a block diagram showing a construction of a server device 20a of a settlement system according to the present embodiment.

FIG. 11 shows a settlement processing procedure RT20 according to the present embodiment.

FIG. 12 shows a diagram showing a flowchart of an information registration processing in a collective suspension representation processing system or a settlement representation processing system according to the present embodiment.

FIG. 13 is a diagram showing a flowchart of a collective suspension representation processing according to the present embodiment.

FIG. 14 is a diagram showing a flowchart of information registration of a collective suspension processing system according to the present embodiment.

FIG. 15 is a diagram showing a flowchart of a collective suspension processing according to the present embodiment.

FIG. 16 is a diagram showing a flowchart of a settlement representation processing according to the present embodiment.

### DESCRIPTION OF THE PREFERRED EMBODIMENTS

An embodiment according to the present invention is described in detail with referencing to the drawings in the following.

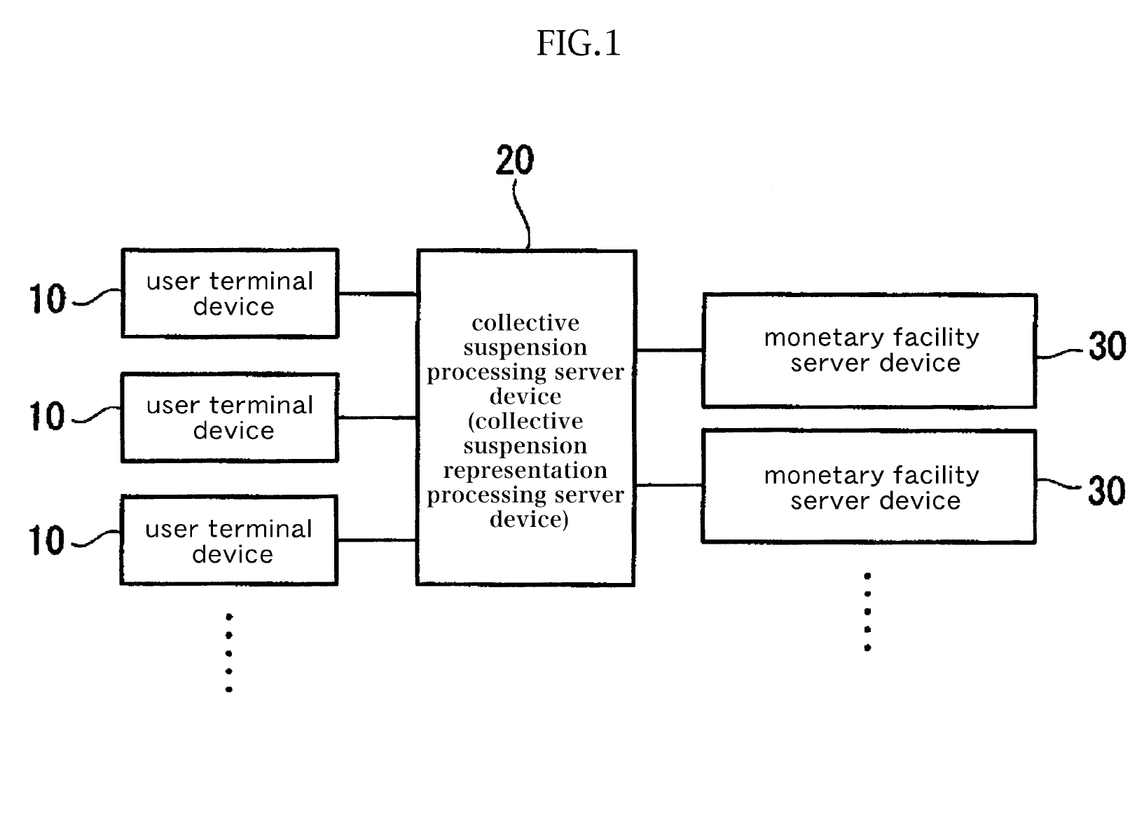

FIG. 1 is a diagram showing a structure of the collective suspension processing system (that is, the collective suspension representation processing system) according to the present embodiment. The collective suspension processing system comprises the user terminals 10, the collective suspension processing server device 20 (that is, the collective suspension representation processing server device) and the monetary facility server devices 30.

The merchant who provides the collective suspension processing service constructs the collective suspension processing server device 20 and is tied up with plural monetary facilities and credit card companies having the monetary facility server devices 30. The user terminal 10, which is operated by the user of collective suspension processing, selects plural bank cards and/or credit cards desired to be suspended and sends a suspension request to the collective suspension processing server device 20. When receiving the suspension request, the collective suspension processing server device 20 sends the suspension requests of the selected cards to the monetary facility server devices 30 of each monetary facility and credit card company. When receiving the suspension request, the monetary facility server device 30 executes the suspension processing of the corresponding card. Consequently, the user can collectively suspend the bank cards and the credit cards of plural different bank facilities and credit card companies.

The user terminal device 10 is the terminal used by the user such as the personal computer, the mobile phone terminal, PDA (Personal Digital Assistants) and so on, and connected to the collective suspension processing server device 20 via the network such as the Internet or the mobile phone network.

The user terminal device 10 sends the user ID and the password to the collective suspension processing server device 20 and logs on to the collective suspension processing system following to the operation of the user who has executed the initial registration to the collective suspension processing system by the predetermined computer processing.

Based on the user's operation, the terminal device 10 makes the encrypted monetary information by encrypting the card information of the bank cards and the credit cards of which the user desires to use the collective suspension processing system using the encryption key. Such encrypted monetary information are sent to the collective suspension processing server device 20 and registered.

When the user loses the bank cards or the credit cards and desires to suspend the lost cards, the user operates the terminal device 10 to select the previously registered bank cards or credit cards, and to send the suspension request and the decryption key for decrypting the above described encrypted monetary information to the collective suspension processing server device 20, and then, the user uses the collective suspension processing system.

The monetary facility server devices 30 is the server device provided by the bank facility or the credit card company which issues the cards to the user. The monetary facility server devices 30 is connected to the collective suspension processing server device 20 via the network such as the Internet.

The monetary facility server devices 30 acquires the decrypted monetary information described herein later, which is received with the suspension request, from the collective suspension processing server device 20. Then, the monetary facility server devices 30 executes the suspension processing of the cards based on the decrypted monetary information.

The collective suspension processing server device 20 is the server device to provide the collective suspension processing service.

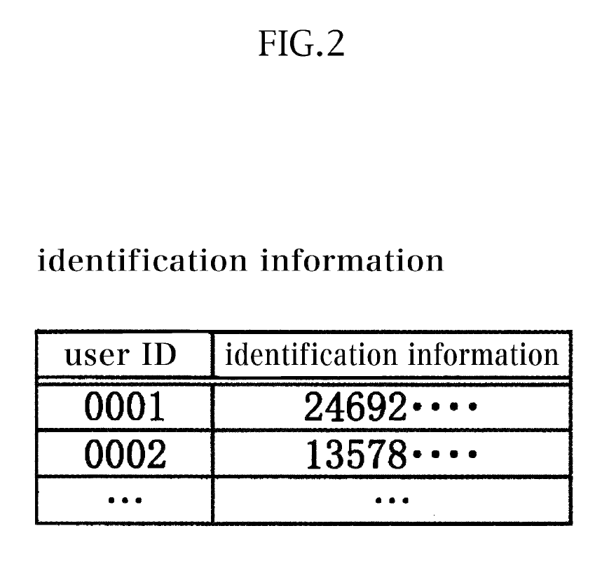

FIG. 2 shows the table structure to store the user identification information according to the embodiment of the present invention. As shown in FIG. 2, the table structure stores the user IDs and the identification information with correlating each other.

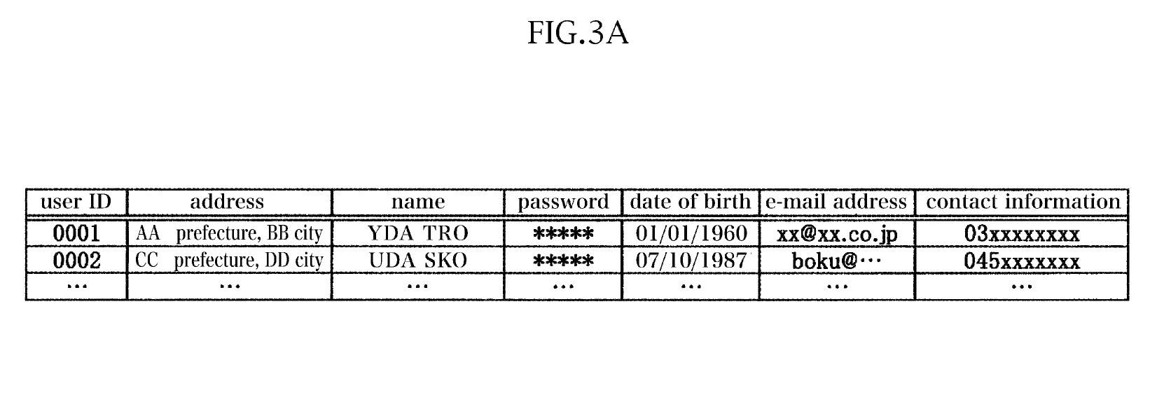

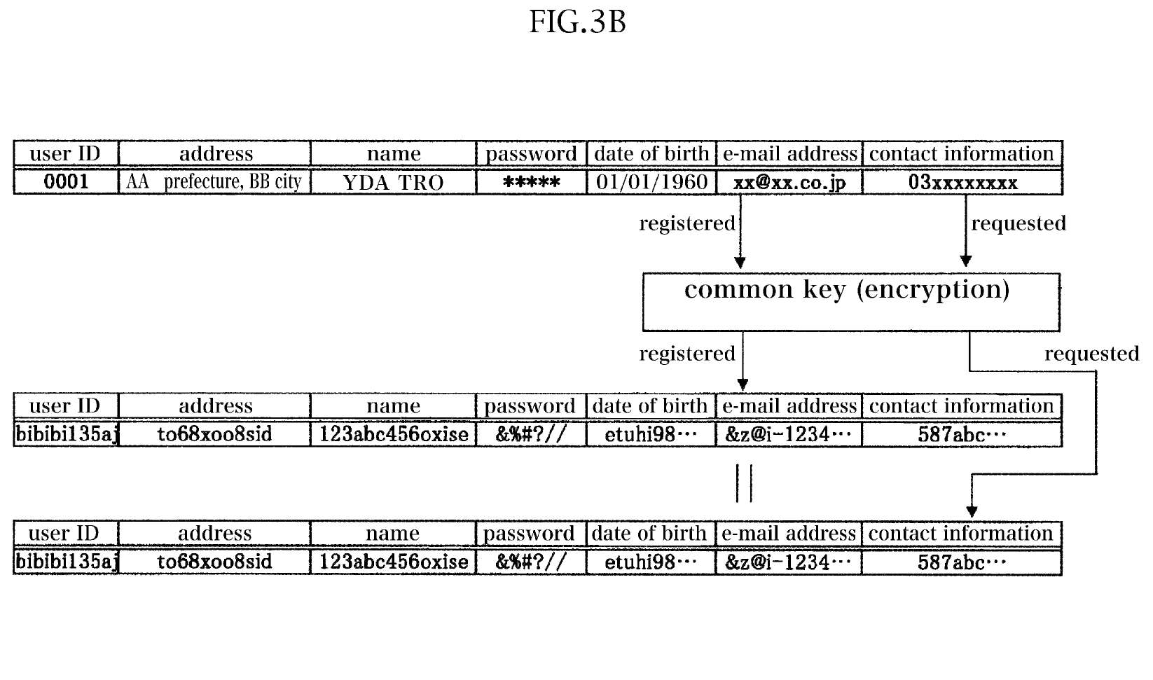

FIG. 3A shows the table structure to store the authorization information of another user according to the embodiment of the present invention. As shown in FIG. 3A, the table structure stores the addresses, the names, the passwords, the birth dates, the electronic mail addresses and the contact information such as telephone numbers with correlating to each user ID. The user ID means the number for specifying the user uniquely. The address means the address of the user. The name means the name of the user. The password means the password used for the user authorization executed by the authorization unit 20-9 as described below. In the example of top line of FIG. 3A, the user ID is ‘0001’, the address is ‘AA prefecture, BB city’, the name is ‘YDA TRO’, the password is ‘*****’, the birth date is ‘Jan. 1, 1960’, the electronic mail address is ‘xx@xx.co.jp’ and the contact information is ‘03XXXXXXXX’. Incidentally, the user ID, the address, the name, the password and so on are stored into the authorization table after encrypted.

FIG. 3B is an example of the table, which is located in the server device according to the embodiment of the present invention, to store the received information as the encrypted data which is encrypted using the common key generated dynamically. The common key is generated dynamically by each field unit and is put into the sequence of letters and numerals. Then, the encrypted sequence of letters and numerals is generated so that the order of source sequence is not mixed up and the number of letters and numerals is equal to or less than quintuple of the source sequence. Incidentally, the common key is common by each field unit, and so the information registered in the same field are encrypted using the same common key. Therefore, these information can be searched using perfect match searching even under the state of encrypted. By encrypting the authorization information using the common key, the authorization table stores ‘bibibi135ai’ as the user ID, ‘to 68xoo8sid’ as the address, ‘123abc456oxise’ as the name, ‘&%#?//’ as the password, ‘etuhi98 . . . ’ as the birth date, ‘&z@i-1234 . . . ’ as the electronic mail address and ‘587abc . . . ’ as the contact information.

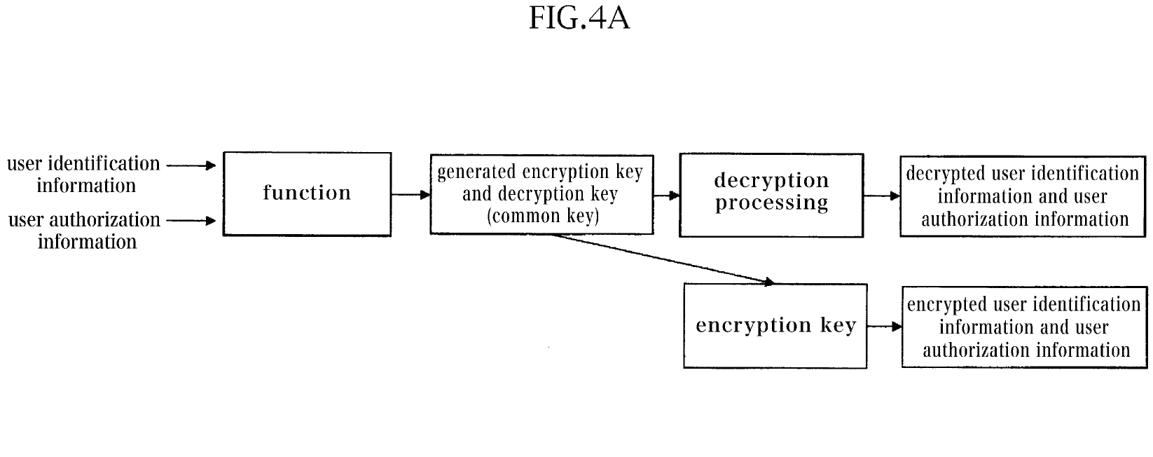

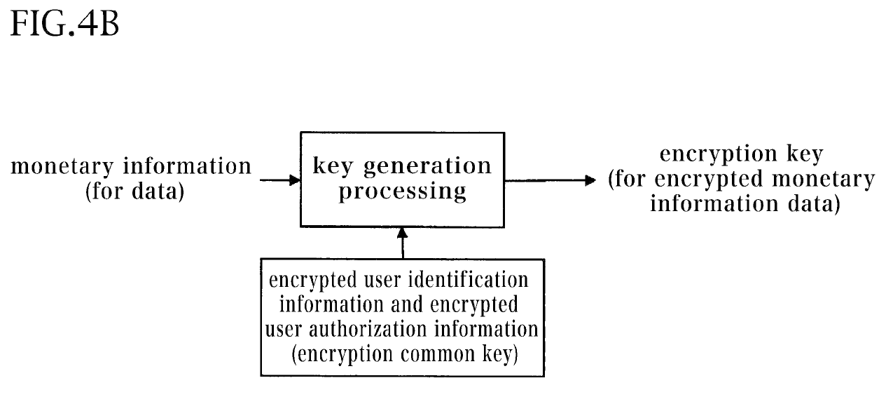

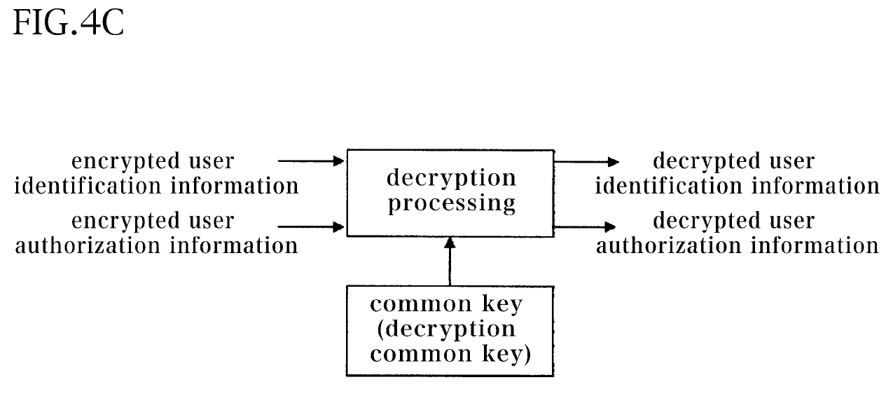

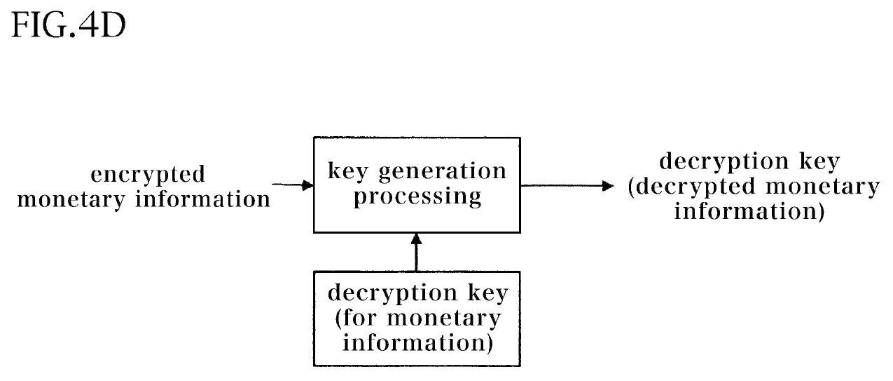

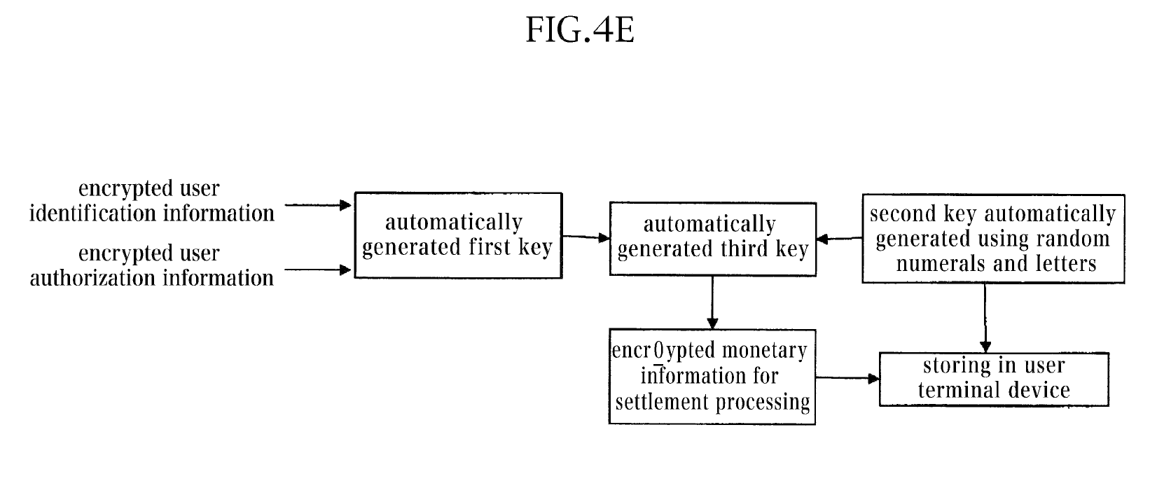

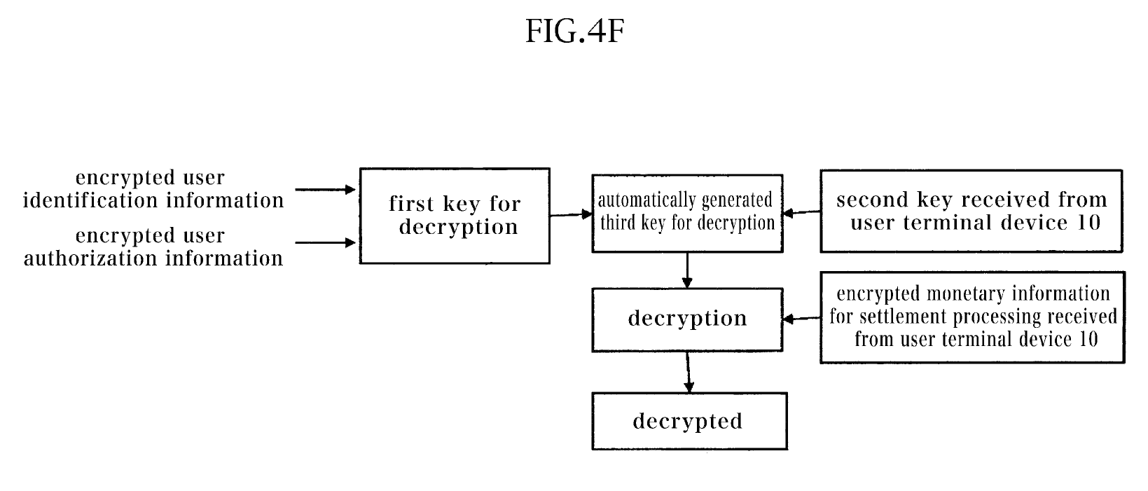

FIG. 4A is the diagram showing the processing to encrypt and decrypt the user identification information and the user authorization information according to the embodiment. As shown in FIG. 4A, when the user identification information and the user authorization information are sent from the user terminal device 10 to the collective suspension processing server device (i.e. the collective suspension representation processing server device) 20, the common keys corresponding the encryption key and the decryption key are generated using function processing, then, the decryption processing or the encryption processing is executed using the corresponding common key.

FIG. 4B is the diagram showing the processing to encrypt the user monetary information according to the embodiment. As shown in FIG. 4B, when the monetary information for data is sent from the user terminal device 10 to the collective suspension processing server device (i.e. the collective suspension representation processing server device) 20, the key generation processing is executed based on the encrypted user identification information and the encrypted user authorization information, both of which are encrypted using the common key for the encryption described above. Consequently, the monetary information for data become the encryption key (i.e. the encrypted monetary information data) encrypted using the encryption key.

FIG. 4C is a diagram showing the processing to decrypt the user identification information and the user authorization information according to the embodiment. As shown in FIG. 4C, the encrypted user identification information and the encrypted user authorization information, which are encrypted using the way described above, are decrypted using the common decryption key according to the common key. Consequently, the user identification information and the encrypted user authorization information can be acquired.

FIG. 4D is a diagram showing a processing of the kept key generation processing unit (not shown in Figures) in the user terminal device 10 according to the present embodiment. As shown in FIG. 4D, the decryption key (that is, the decrypted monetary information) can be acquired from the encrypted monetary information data, which is encrypted using the way described above, by executing the key generation processing using the decryption key for the monetary information.

FIG. 4E is a diagram showing the processing of an encryption processing unit (not shown in Figures) in the collective suspension representation processing server device 20 according to the present embodiment. As shown in FIG. 4E, the first key is automatically generated using the encrypted user identification information and the encrypted user authorization information, the second key is automatically generated using random letters and numerals, then, the third key is generated using the first and second keys. Next, the monetary information for the settlement processing is encrypted. The monetary information for the settlement processing is stored into the user terminal device 10 with the second key.

FIG. 4F is the diagram showing the decryption processing in the collective suspension representation processing server device 20 according to the present embodiment. As shown in FIG. 4F, the first key is the base of the decryption using the encrypted user identification information and the encrypted user authorization information. The second key is received from the user terminal device 10. The third key is automatically generated using the first and second keys. Then, the encrypted monetary information for the settlement processing is received from the user terminal device 10 and decrypted using the third key. Consequently, the decrypted monetary information can be acquired.

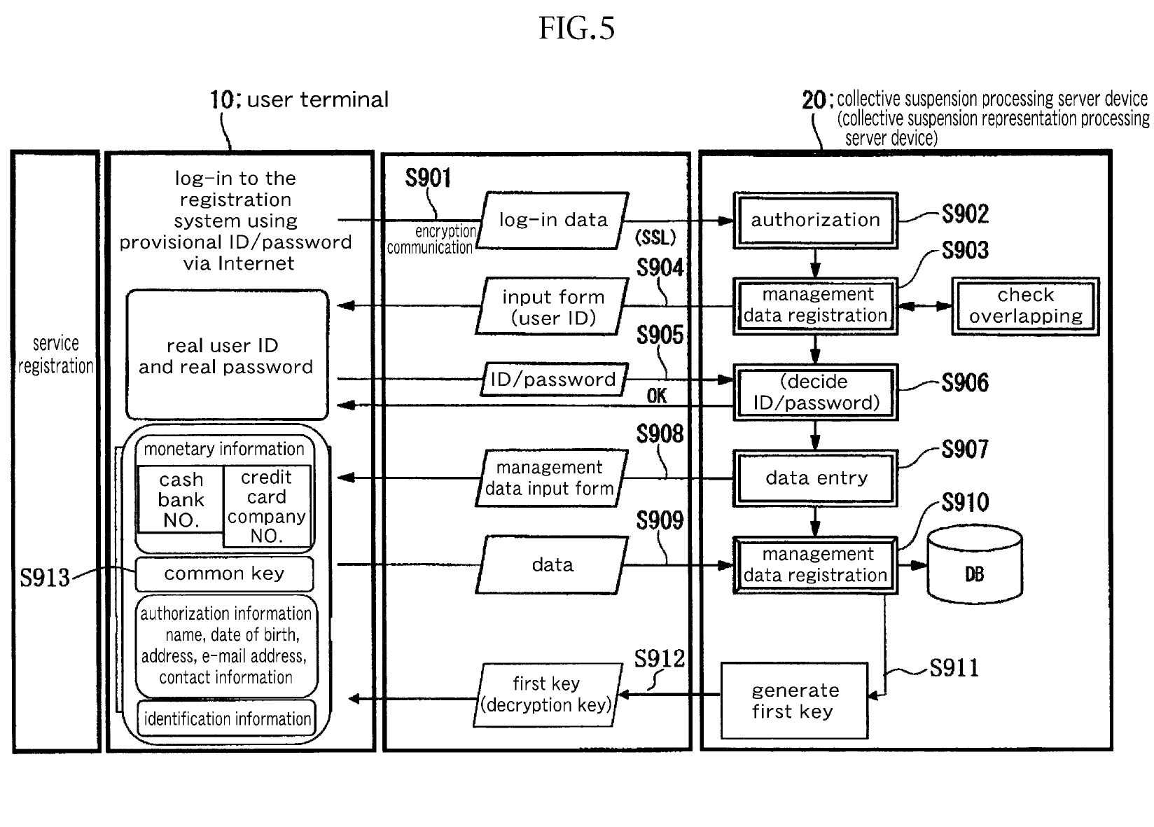

FIG. 5 is the sequence diagram showing the procedure for the service registration according to the present embodiment. The user terminal 10 sends the provisional user ID and the provisional password, which are issued based on the operation of the computer device via the network, to the collective suspension processing server device (i.e. the collective suspension representation processing server device) 20 (step S901). When receiving the data, the collective suspension processing server device (i.e. the collective suspension representation processing server device) 20 executes the user authorization using the authorization unit (20-9) (step S902), and stores the attribute information of the user into the management database (20-9) using the management data registration unit (20-9) if the user authorization succeeds (step 903). At this time, the attribute information of the user is checked whether already registered. Then, the collective suspension processing server device (i.e. the collective suspension representation processing server device) 20 sends the input form for the user ID and password to the user terminal device 10 (step S904). The user terminal device 10 sends the user ID and the passwords, which is input to the input form, to the collective suspension processing server device (i.e. the collective suspension representation processing server device) 20 (step SS905). The collective suspension processing server device (that is, the collective suspension representation processing server device) 20 decides the user ID and the password received from the user terminal device 10 as the user's proper ID and password (S906). The collective suspension processing server device (i.e. the collective suspension representation processing server device) 20 stores the user ID and the password into the attribute information table (step S907), and sends the management data input form to the user terminal device 10 (step S908).

The user terminal device 10 sends the card information, which is input to the management data input form, to the collective suspension processing server device (i.e. the collective suspension representation processing server device) 20 (step S909).

The collective suspension representation processing server device 20 encrypts the received monetary information by executing the calculation processing, which can contain the predetermined random number calculating, using the encryption key generated by the key generation processing unit, and stores the encrypted monetary information into the predetermined storage unit (step S910). At the same time, the second key (hereinafter, there is a case it is called ‘the decryption key’) is generated (step S911) and sent to the user terminal 10 (step S912).

Incidentally, in the case of the collective suspension processing, only the monetary information is encrypted using the public key and sent to the collective suspension processing server device 20, but the authorization information and the identification information of the user are encrypted using the common key and sent to the collective suspension processing server device 20. The encryption using the common key makes the searching of the information to be possible. Incidentally, the usage of the secret key may cause some inconvenience when the searching is executed. Therefore, the common key is sent to the collective suspension processing server device 20 and the encryption key and the secret key (i.e. the decryption key) of the monetary information are stored into the user terminal device 10. In contrast, in the case of the collective suspension representation processing, the encryption uses the common key and the second key (i.e. the decryption key) is sent to the user terminal 10 from the collective suspension representation processing server device 20, and then, the second key is stored into the user terminal 10.

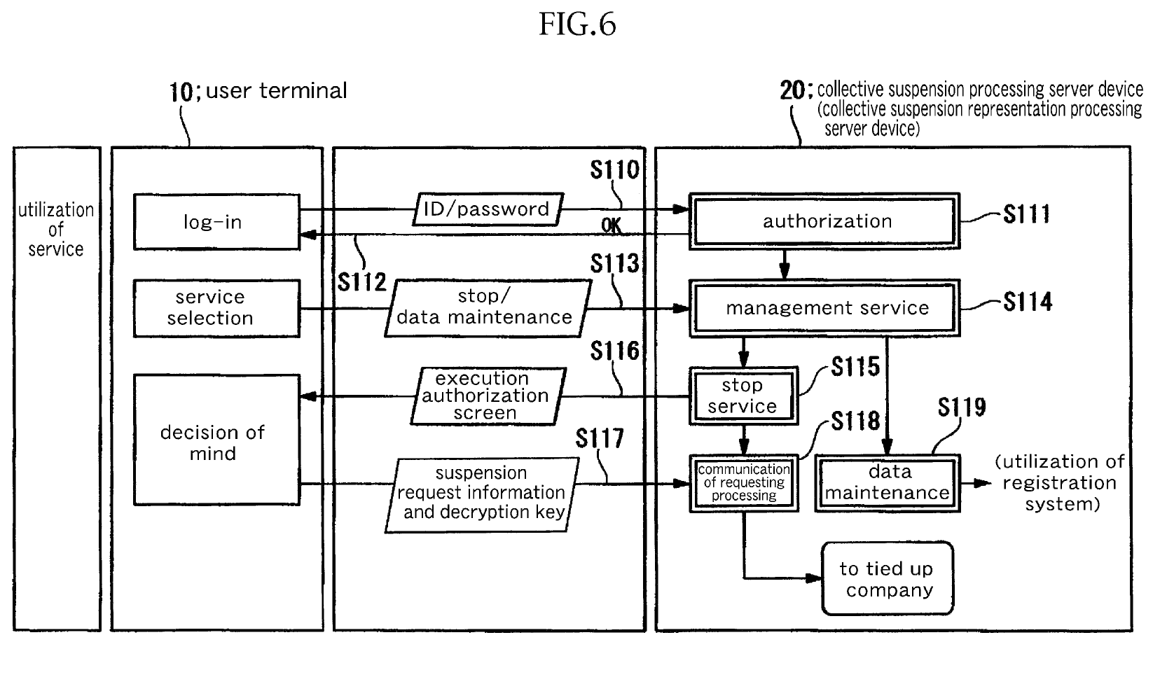

FIG. 6 is the sequence diagram showing the procedure for requesting the suspension processing according to the present embodiment. The user terminal device 10 sends the user ID and the passwords to the collective suspension processing server device 20 (step S110). When receiving the data, the collective suspension processing server device (i.e. the collective suspension representation processing server device) 20 executes the user authorization using the authorization unit 20-9 (step S111), and sends the service selection form to the user terminal device 10 if the user authorization succeeds (step S112). The user can select the suspension service or the data maintenance service using the service selection form. The user terminal device 10 sends the selection information to the collective suspension processing server device 20 (step S113). The collective suspension processing server device 20 executes the above described service registration when the data maintenance is selected (step S119). When the suspension service is selected, the collective suspension processing server device 20 sends the execution authorization screen to the user terminal device 10 (step S116). The user terminal device 10 sends the decryption key to the collective suspension processing server device 20 with the suspension request information, that is, the data input to the execution authorization screen (step S117). The collective suspension processing server device (i.e. the collective suspension representation processing server device) 20 extracts the selected monetary information of the monetary facilities using the suspension service processing unit (not shown in Figures) and sends the extracted information to the monetary facility server device 30 of the corresponding tied up company (step S118).

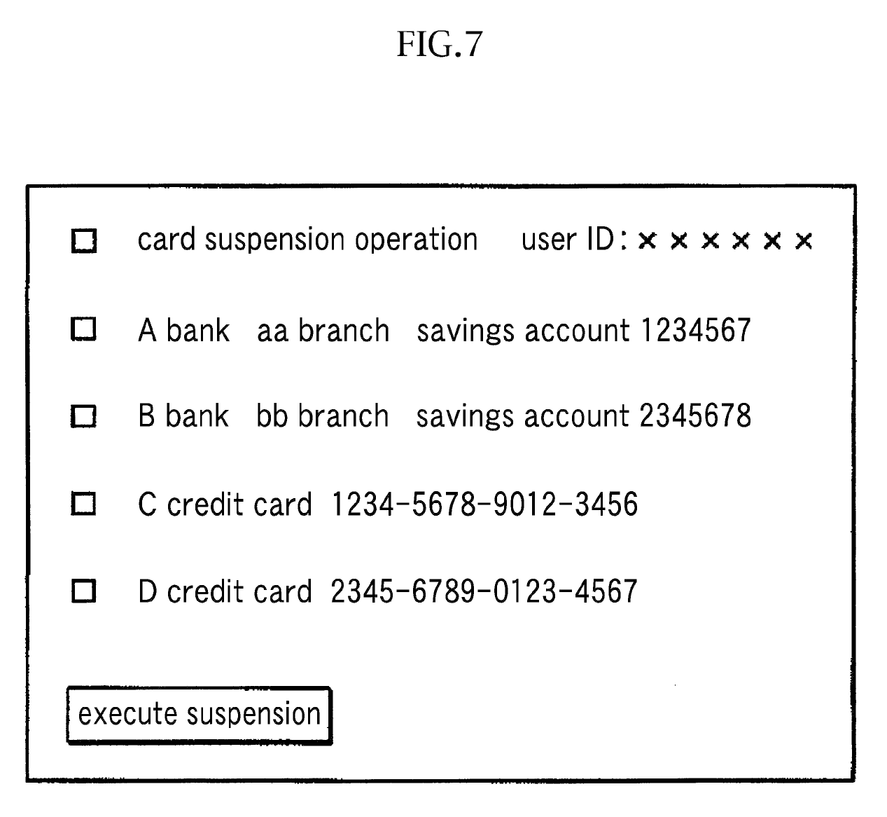

FIG. 7 is an example of an execution authorization screen displayed by the user terminal device 10 based on the processing of step S116 by the collective suspension processing server device 20 according to the present embodiment. The execution authorization screen displays the user ID, the button for executing the suspension and the checkboxes for selecting the plural cards registered to the card suspension operation on the execution authorization screen. If the card suspension operation of upper side is selected, all registered cards are suspended. In addition, the cards which should be suspended can be selected individually. When the suspension execution button is clicked, the user terminal device 10 sends the input data and the decryption key to the collective suspension processing server device 20.

Incidentally, the collective suspension processing server device (i.e. the collective suspension representation processing server device) 20 sends the monetary information according to the suspension to the monetary facility server device 30, but the detail description and figures of this action is omitted. The card management server device 30 suspends the card based on the predetermined procedure and notifies the suspension of the card to the collective suspension processing server device (i.e. the collective suspension representation processing server device) 20. The collective suspension processing server device (i.e. the collective suspension representation processing server device) 20 confirms the suspension of the card and notifies the termination of the suspension processing to the user terminal 10.

As described above, according to the present embodiment, the collective suspension processing server device (i.e. the collective suspension representation processing server device) can collectively suspend the plural different cards issued by plural monetary facilities and the credit card companies. Moreover, the encryption keys and the decryption keys for encrypting and decrypting the cards are generated dynamically using the user authorization information and the user identification information, and so the keys are specified by each user. Furthermore, the decryption keys need not to be kept in the server device, because they are kept by the users. Therefore, it can be prevented that cards of all users leak at the same time.

The suspension processing can also be executed by storing the programs for realizing the user terminal 10, the collective suspension processing server device (i.e. the collective suspension representation processing server device) 20 and the monetary facility server device 30 to the computer-readable storage medium, installing the programs into the computer system and making the programs to run. Incidentally, the above described ‘computer system’ can contain the OS and the hardware such as peripheral device. The ‘computer system’ needs to comprise the means for providing the web sites (or means for displaying the web site) when using the www system. The ‘computer-readable storage medium’ means the storing device such as the flexible disk, the magnet-optical disk, the ROM, the flash memory or other kind of the writable nonvolatile memory, CD-ROM or other kind of the movable memory, the hard disk located in the computer system and so on.

Moreover, the ‘computer-readable storage medium contains the medium temporarily storing the programs such as the DRAM or other kind of the volatile memory located in the computer system which is used as the server of the client when the programs are sent via the network such as the Internet or the communication line such as the telephone line. Moreover, the above described program can be carried from the computer system comprising the storage unit into which the program is stored to another computer system via the carrying medium or by the carrier wave in the carrying medium. Incidentally, ‘carrying medium’ for carrying the program is the medium having the function to carry the information, for example, the network such as the Internet and the communication line such as the telephone line.

The above described program contains the program for realizing a part of above described functions. Furthermore, the above described program contains the programs for realizing the above described functions by cooperating with the programs previously stored in the computer system, that is, the difference program.

An embodiment of the present invention is described in detail with referencing to the Figures hereinabove. However, the specific structure of the present invention is not limited to the above described structure, and many kind of the design changes can be done within the extent not to deviate the summary of the invention. For example, the present invention can be applied to the data management of the representation service such as the gas, the electric power, water supply or the reservation system.

### Another Embodiment

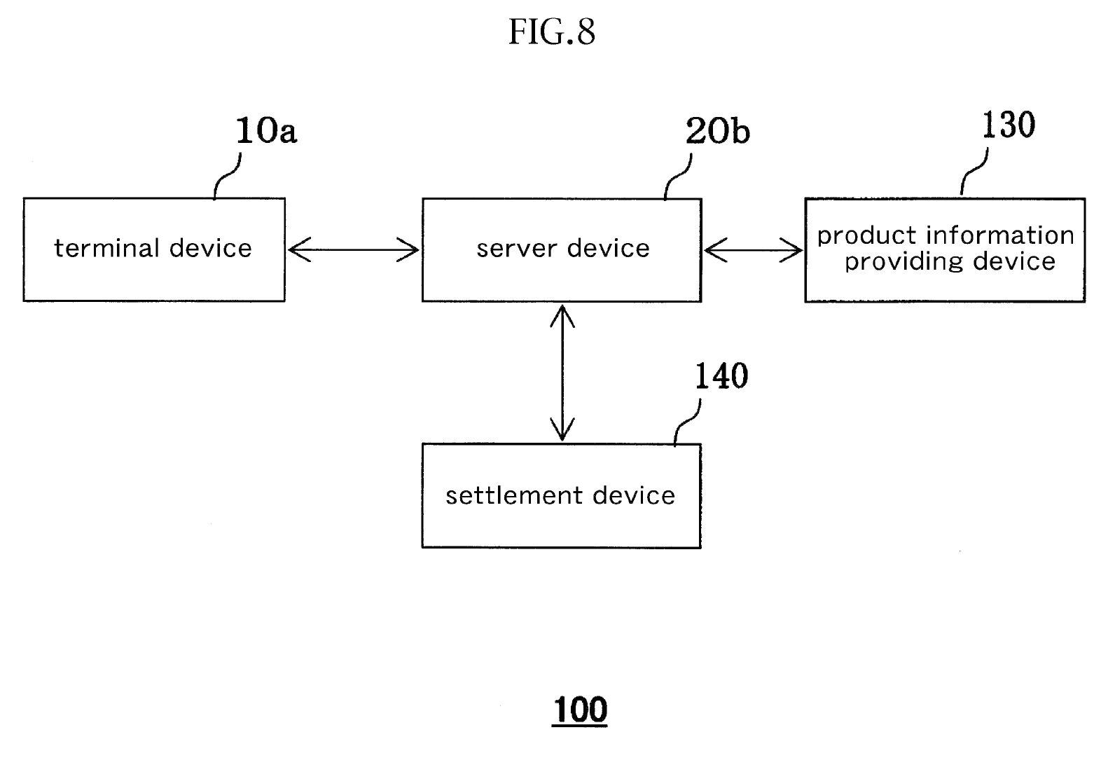

FIG. 8 shows the construction of settlement system 100 according to another embodiment of the present invention. The settlement system 100 is the system to realize the settlement service which notifies the information for urging the confirmation of the settlement and executes the settlement after obtaining user's approval using registered user's card information and other kinds of the monetary information, when the order for purchasing the product is executed via the Internet, for example.

The settlement system 100 comprises the user's owned terminal device 10a such as the personal computer or the mobile phone device etc., the server device 20a to provide the above described settlement service, the product information providing device 130 to provide the product information and the settlement device 140 to settle accounts using the card information.

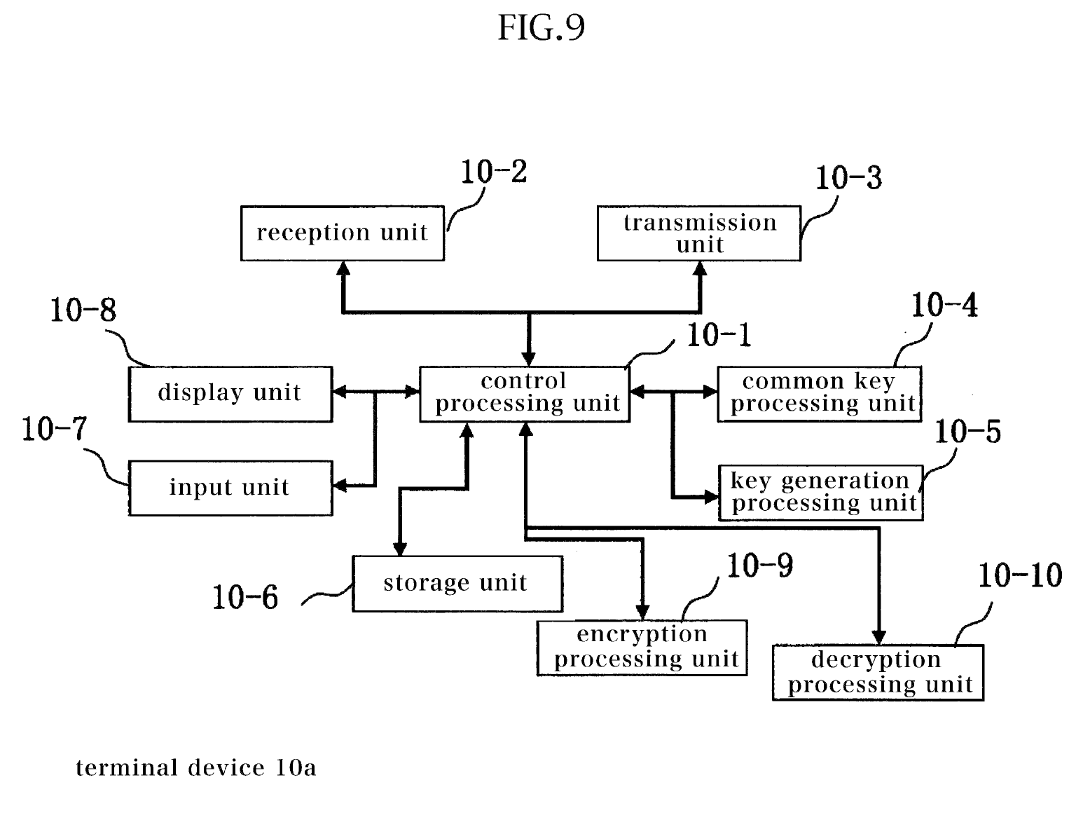

FIG. 9 is a block diagram showing the construction of the terminal device 10a of the settlement system according to the present embodiment. As shown in FIG. 9, the terminal device 10a comprises the control processing unit 10-1, the reception unit 10-2, the transmission unit 10-3, the common key processing unit 10-4, the key generation processing unit 10-5, the storage unit 10-6, the input unit 10-7, the display unit 10-8, the encryption processing unit 10-9 and the decryption processing unit 10-10.

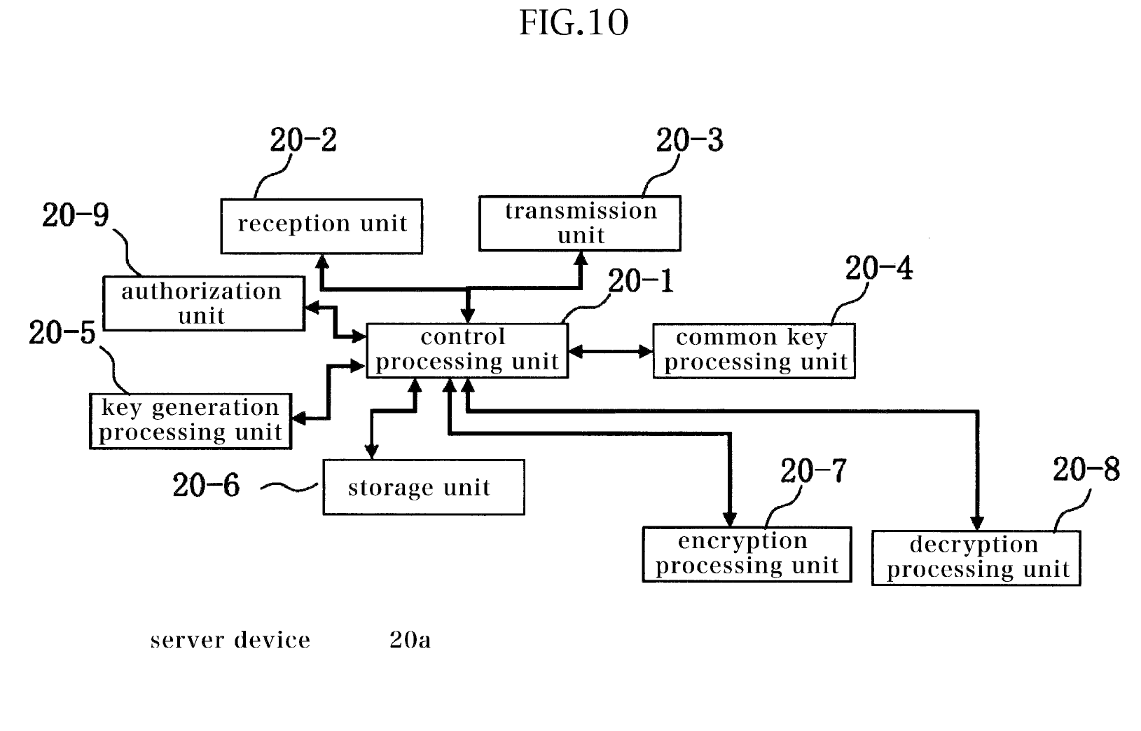

FIG. 10 is a block diagram showing the construction of the server device 20a of the settlement system according to the present embodiment. As shown in FIG. 10, the server device 20a comprises the control processing unit 20-1, the reception unit 20-2, the transmission unit 20-3, the common key processing unit 20-4, the key generation processing unit 20-5, the storage unit 20-6, the encryption processing unit 20-7, the decryption processing unit 20-8 and the authorization unit 20-9.

The relationship between the terminal device 10a and the server device 20a is described with referencing to FIGS. 9 and 10.

Firstly, the user operates the input unit 10-7 of the terminal device 10a for inputting the password, the card information in connection with the credit card number, expiration date and so on, then, the control processing unit 10-1 sends the input password etc. to the server device 20a via the transmission unit 10-3.

In this operation, the user additionally operates the input unit 10-7 for inputting the identification information and the authorization information of the user owning the terminal device 10a, and the control processing unit 10-1 sends the user identification information and the user authorization information to the server device 20a when sending the above described monetary information to the server device 20a.

The reception unit 20-2 of the server device 20a receives the user identification information, the user authorization information and the monetary information from the terminal device 10a. Then, the user identification information, the user authorization information and the monetary information are encrypted by executing the calculation processing which can contain the predetermined random numbers calculation. The calculation processing uses the encryption key in which the number of letters is provided by the common key processing unit 20-4 and generation of the encryption key is executed by the encryption processing unit 20-7. Then, the result of encrypting the user identification information, the user authorization information and the monetary information are stored into the storage unit 20-6, that is the storage unit for server device, with corresponding each other. Moreover, the second key and the encrypted monetary information are sent to the terminal device 10a via the transmission unit 20-3. The second key and the encrypted monetary information are provided to the control processing unit 10-1 through the reception unit 10-2 of the terminal device 10a, and stored into the storage unit 10-6.

Thus, the server device 20a encrypts the monetary information by each field unit, stores the encrypted monetary information into the storage unit 20-6 and manages them. The encryption can be executed by each plural card information when stored into the storage unit 20-6 and managed. For example, it is possible to encrypt the plural card information by each credit card company or bank facility, by each kind of card or number of owned card, or based on the user's arbitrary selected combination.

After this, the user operates the input unit 10-7 of the terminal device 10a to execute the order for purchasing the products provided from the product information providing device 130 by communicating with the product information providing device 130 via the Internet.

When ordering, the user operates the input unit 10-7 to input the user identification information, the card information such as the card number of the credit card, the product information according to the product to which the user wants to purchase.

Then, the control processing unit 10-1 sends the user identification information, the user authorization information, the monetary information and the product information to the product information providing device 130 via the transmission unit 10-3, as the order information.

The product information providing device 130 receives the order information from the terminal device 10a, and then, sends it to the server device 20a. The reception unit 20-2 of the server device 20a receives the order information and outputs it to the encryption processing unit 20-7. Incidentally, the order information can be input or read using the predetermined computer device located in the product information providing device 130 (for example, the personal computer or the card reader).

The common key processing unit 20-4 decides the letters and numerals. The encryption processing unit 20-7 executes the encryption by the calculation processing which can contain the predetermined random number calculation, and sends the encrypted order information to the control processing unit 20-1.

The control processing unit 20-1 uses the encrypted user identification information and the encrypted user authorization information stored in the storage unit 20-6 for searching the corresponding encrypted monetary information. Moreover, the control processing unit 20-1 searches the encrypted monetary information perfectly matches with the encrypted user identification information and/or the encrypted user authorization information, which are sent from the product information providing device 130 and encrypted by the encryption processing unit 20-7, from the searched encrypted monetary information. For example, the sequence of letters and numerals corresponding to the name contained in the encrypted monetary information, the sequence of letters and numerals corresponding to the electronic mail address contained in the encrypted monetary information and/or the sequence of letters and numerals corresponding to the identification number contained in the identification information are compared and decided whether accord or not. If the identification numbers are identical, encrypted sequences of letters and numerals corresponding to the card information will accord because these information are encrypted using the common encryption key, and so such decision method can be realized.

The control processing unit 20-1 judges the settlement to be executed by the user, generates the settlement confirmation information for making the user to confirm the settlement and sends the settlement confirmation information to the transmission unit 10-3, when the control processing unit 20-1 has succeeded to search the encrypted monetary information which is stored in the storage unit 20-6 with the corresponding encrypted user identification information and the corresponding encrypted user authorization information and which completely identical to the encrypted user identification information and/or the encrypted user authorization information sent from the product information providing device 130 and encrypted by the encryption processing unit 20-7. For example, the settlement confirmation information may be sent to the electronic mail address contained in the user authorization information as an electrical mail. The transmission unit 10-3 sends the settlement confirmation information to the terminal device 10a. In this case, the control processing unit 20-1 and the transmission unit 20-3 behaves as the first server device transmission unit.

The reception unit 10-2 of the terminal device 10a receives the settlement confirmation information and outputs it to the control processing unit 10-1. Then, the control processing unit 10-1 urges the user to confirm settlement by displaying the settlement confirmation screen on the display unit 10-8. When receiving the settlement confirmation information as an electrical mail, the user may confirm the text of the electrical mail, or confirm the screen of the settlement confirmation form by accessing to the server device 20a from the URL (Uniform Resource Locator) contained in the text of electrical mail, for example. In both cases, the user can confirm the massage such as ‘Have you ordered products of xxx dollars?’

The user looks the settlement confirmation screen and admits the settlement by operating the input unit 10-7, then, the control processing unit 10-1 generates the settlement admission information, reads the second key and the encrypted monetary information for settlement processing from the storage unit 10-6, and sends these settlement admission information and the second key to the server device 20a via the transmission unit 10-3. In this case, the control processing unit 10-1 and the transmission unit 10-3 behaves as the terminal device transmission unit.

The reception unit 20-2 of the server device 20a receives the settlement admission information, the second key and the encrypted monetary information for settlement processing, then, outputs the settlement admission information to the storage unit 20-6 and outputs the second key and the encrypted monetary information for settlement processing to the decryption processing unit 20-8. The storage unit 20-6 generates the third key and reads the encrypted monetary information in connection with the settlement admission information when the settlement admission information is provided, and generates the third key using the first and second keys and outputs it to the decryption processing unit 20-8 when the numerals and letters are provided by the common key processing unit 20-4.

The decryption processing unit 20-8 decrypts the decryption monetary information and sends the decrypted monetary information to the transmission unit 20-3. The transmission unit 20-3 sends the monetary information to the settlement device 140 and makes the settlement device 140 to settle. In addition, the transmission unit 20-3 sends the settlement admission information to the product information providing device 130 for notifying the completion of the settlement procedure, and makes the product information providing device 130 to ship the product. Incidentally, in this case, the encryption processing unit 20-7, the decryption processing unit 20-8 and the transmission unit 20-3 behave as the second server device transmission unit.

In contrast, when the user operates the input unit 10-7 to reject the settlement, the control processing unit 10-1 generates the settlement rejection information and sends it to the server device 20a via the transmission unit 10-3. In this case, the control unit 10-1 does not send the decryption key to the server device.

The reception unit 20-2 of the server device 20a receives the settlement rejection information and sends it to the transmission unit 20-3. The transmission unit 20-3 sends the settlement rejection information to the product information providing device 130 for canceling the order and sends the settlement rejection information to the settlement device 140 for stopping the execution of the settlement.

Incidentally, the authorization unit 20-9 executes the authorization of the user and acquires the user ID, password and so on notified from the user terminal 10. Then, the authorization unit 20-9 compares the notified ID with the user ID stored in the attribute information table. If the identical ID is found, the authorization unit 20-9 compares between the password stored with correlating to the identical ID and the notified password, and checks whether these passwords are identical. The authorization unit 20-9 judges the user authorization to be successful when these passwords are identical. In contrast, the authorization unit 20-9 judges the user authorization to be failure when these passwords are not identical or there is no stored passwords identical with the notified password.

Incidentally, when the third person pretends to be the user, for example, using the card lost by the user, the third person inputs the lost card information to the third person's own terminal device etc., sends it to the product information providing device 130 and executes the order for purchasing the products. As a result, the product information providing device 130 sends the card information to the server device 20a, then, the predetermined processing similar to the above described processing is executed and the settlement admission information is sent.

However, the destination address of the settlement admission information is the electronic mail address of the PC (Personal Computer) or the mobile phone contained in the previously registered user identification information or user authorization information, and so the user receives the settlement admission information which the user is unaware of. Therefore, the user does not send the settlement confirmation information and the decryption key to the server device 20a.

As a result, the third person pretends to be the user cannot send the decryption key and so cannot execute the settlement processing, because the third person cannot receive the settlement confirmation information even if he(she) tries to execute the electric commerce such as purchasing of the products using the card lost by the user.

Moreover, by registering the authorization information (for example, the electronic mail address) of the person different from the user (for example, father, mother, son, daughter, husband or wife etc.) as the user authorization information, such people can receive the same information as the settlement confirmation information (the timing of sending is not limited, but it is preferable to be sent at the same time). Consequently, when the father not accustomed to the computer device orders a product with or without his intent, for example, the settlement confirmation information is sent to the registered father's and son's electronic mail addresses. The son looks the notification of the settlement confirmation information and learn the settlement is requested to the father. So, the son can confirm whether his father desires to settle, and can send the settlement rejection information by himself when his father does not remember the ordering or his father ordered the product without careful consideration. Incidentally, the designer can optionally set and modify whether to employ the confirmation by the person other than the user or the confirmation by the plural people containing the user as the condition of settlement processing.

Incidentally, the terminal device 10a and the server device 20a according to the settlement system 100 can use the series of processing of the encryption, the decryption, the encryption key generation and the decryption key generation corresponding to the various kinds of the information shown in the FIGS. 4A to 4F, and so the detail description is omitted because it is similar to the above description.

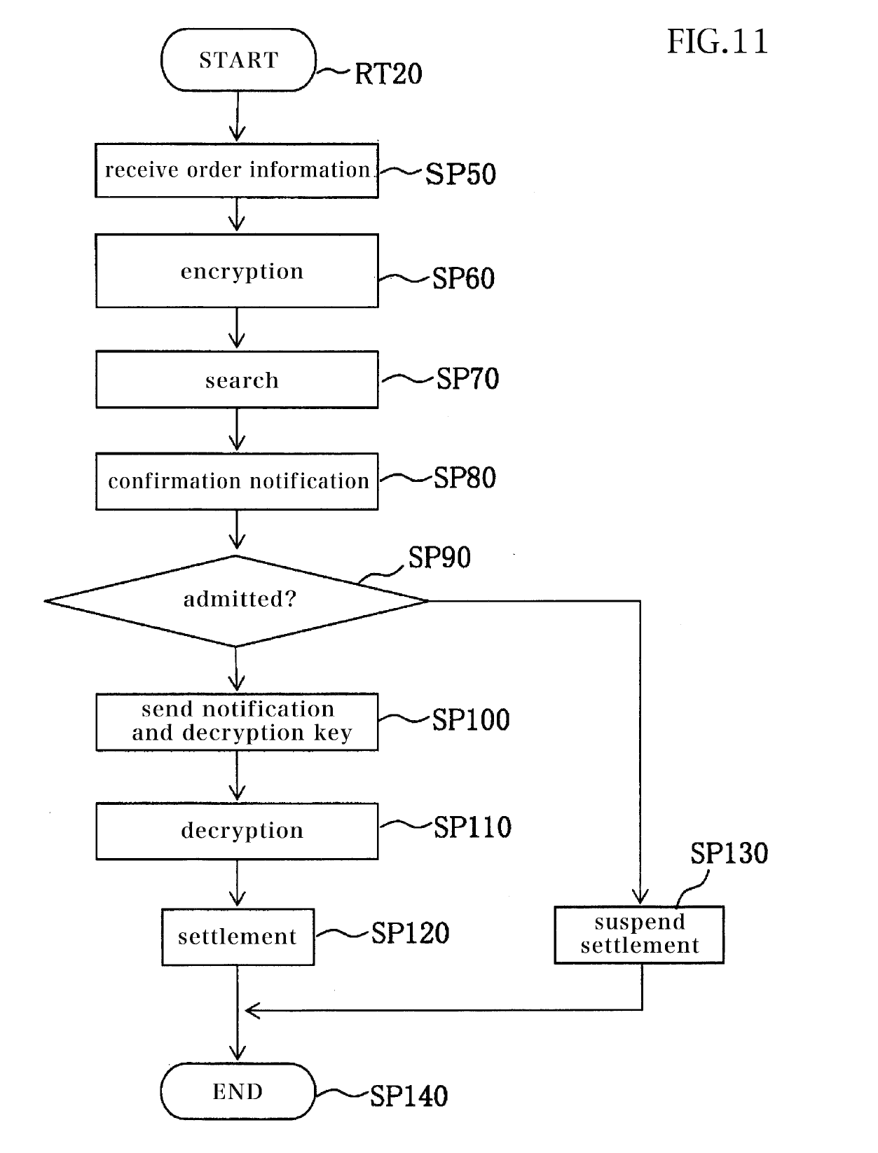

FIG. 11 shows the settlement processing procedure RT20 according to the present embodiment. As shown in FIG. 11, the settlement processing procedure RT120 starts when the product information providing device 130 sends the order information to the server device 120, then, the reception processing unit 200 of the server device 120 receives the order information sent from the product information providing device 130 at step SP50.

At the step SP60, the reception processing unit 200 of the server device 120 encrypts the order information using the common encryption key and sends the encrypted order information to the control unit 240.

At the step SP70, the control unit 240 searches the encrypted card information, which is identical to the card information sent from the product information providing device 130 and encrypted, from among the encrypted card information stored in the storage unit 210. If there is no identical card, the settlement processing finishes (not shown in Figures).

In contrast, if there is an identical card information, the settlement confirmation information is sent to the user's registered electronic mail address and so on at the step SP80. At this time, it is possible to send the settlement confirmation information to the electronic mail address of the person other than the user by previously registering the electronic mail address etc. of the person. Then, the user etc. receives the settlement confirmation information via the transmission and reception processing unit 180 of the terminal device 100.

At the step SP90, the user and/or other person look the settlement confirmation information using the display unit 190 of the terminal device 100. If the execution of the settlement processing is not admitted, the control unit 150 generates the settlement rejection information based on the operation of the operation unit 160 and the transmission and reception processing unit 180 notifies the settlement rejection information to the product information providing device 130 through the server device 120 at the step SP130. Then, the settlement processing procedure RT20 finishes at the step SP140.

In contrast, if the execution of the settlement processing is admitted, the control unit 150 generates the settlement admission information based on the operation of the operation unit 160, reads the decryption key from the storage unit 170 and sends the settlement admitting information and the decryption key to the server device 120 via the transmission and reception processing unit 180 at the step SP100.

At the step 110, the reception processing unit 200 of the server device 120 receives the settlement admission information and the decryption key, then, outputs the settlement admission information to the storage unit 210 and outputs the decryption key to the encryption and decryption processing unit 220. When the settlement admission information is provided, the storage unit 210 reads the encrypted card information corresponding to the provided settlement admission information and outputs it to the encryption and decryption processing unit 220. The encryption and decryption processing unit 220 decrypts the encrypted card information using the decryption key and sends the decrypted card information to the transmission processing unit 230.

At the step SP120, the transmission processing unit 230 sends the card information to the settlement device 140 and makes the settlement device 140 to execute the settlement. In addition, the transmission processing unit 230 sends the settlement admission information to the product information providing device 130 for notifying the execution of the settlement procedure and makes the product information providing device 130 to ship the product. After the series of the above described activities, the settlement processing procedure RT20 finishes at the step SP140.

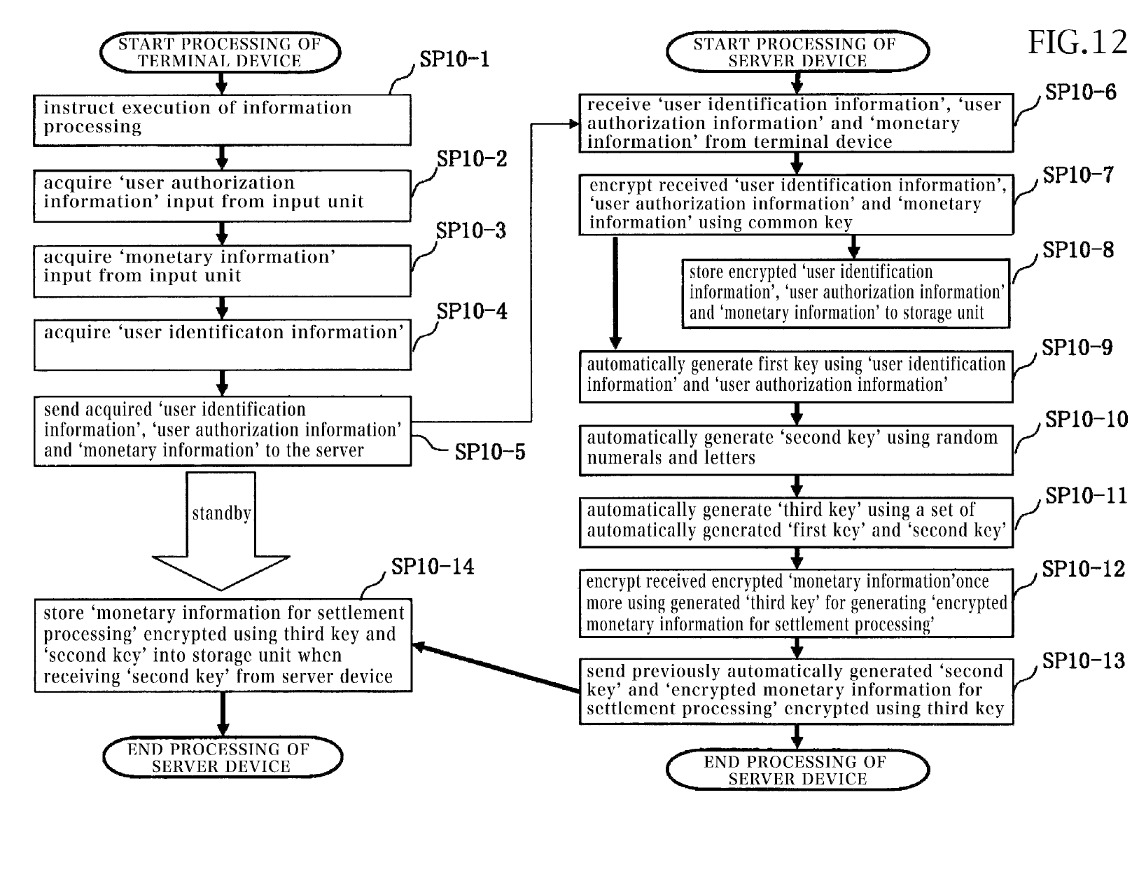

FIG. 12 shows a diagram showing the flowchart of the information registration processing in the collective suspension representation processing server device or the settlement representation processing system according to the present embodiment. As shown in FIG. 12, the user terminal device 10, which works as a terminal device, or terminal device 10a instructs the execution of the information processing (step SP10-1), acquires the ‘user authorization information’ input from the predetermined input unit (step SP10-2), acquires the ‘monetary information’ input from the input unit (step SP10-3), acquires the ‘user identification information’ (step SP10-4) and sends the acquired ‘user identification information’, ‘user authorization information’ and ‘monetary information’ to the server device (step SP10-5).

After this, the collective suspension processing server device (i.e. the collective suspension representation processing server device) 20, which works as a server device, or the server device 20a receives the ‘user identification information’, the ‘user authorization information’ and the ‘monetary information’ from the terminal device (step SP10-6) and encrypts the received ‘user identification information’, ‘user authorization information’ and ‘monetary information’ using the common key (step SP10-7). Incidentally, at this time, the encrypted ‘user identification information’, ‘user authorization information’ and ‘monetary information’ are stored into the predetermined storage unit (step SP10-8). Then, the first key is automatically generated using the encrypted ‘user identification information’, ‘user authorization information’ and ‘monetary information’ (step SP10-9). The ‘second key’ is automatically generated using the random numerals and letters (step SP10-10). The ‘third key’ is automatically generated using a set of the ‘first key’ and the ‘second key’ (step SP10-11). The encrypted ‘monetary information’ is received and encrypted by using the generated ‘third key’, and the ‘encrypted monetary information for settlement processing’ is generated by encrypting the encrypted monetary information once more (step SP10-12). Then, the previously automatically generated ‘second key’ and the ‘encrypted monetary information for settlement processing’ encrypted using the third key are sent to the user terminal device 10 or the terminal device 10a (step SP10-13).

When receiving the ‘second key’ from the collective suspension processing server device (i.e. the collective suspension representation processing server device) 20 or the server device 20a, the user terminal device 10 or the terminal device 10a stores the ‘encrypted monetary information for settlement processing’ encrypted using the third key and the ‘second key’ into the predetermined storage unit (step SP10-14).

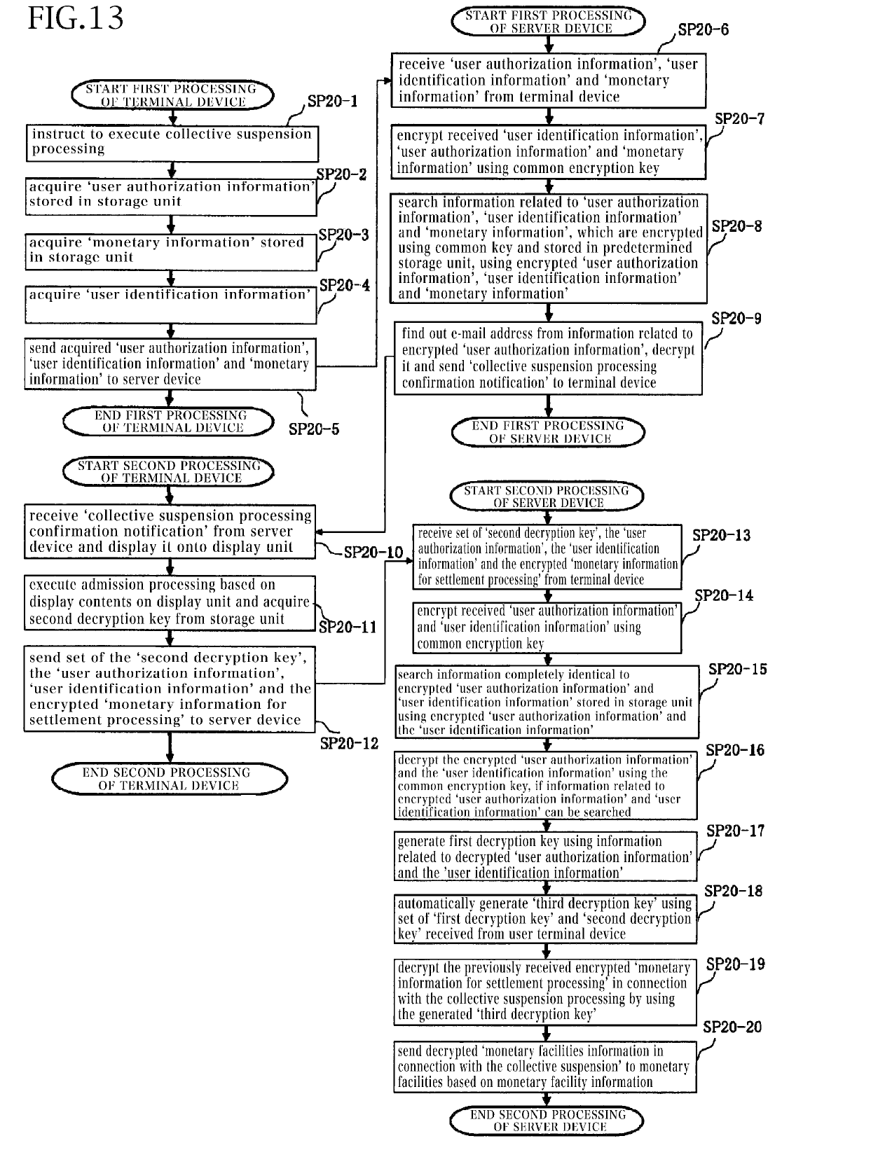

FIG. 13 is the diagram showing the flowchart of the collective suspension representation processing according to the present embodiment. As shown in FIG. 13, if the user terminal device 10, which works as the terminal device, or the terminal device 10a starts the first processing, the execution of the collective suspension processing is instructed (step SP20-1). Then, the ‘user authorization information’ stored in the predetermined storage unit is acquired (step SP20-2). The ‘monetary information’ stored in the storage unit is acquired (step SP20-3). The ‘user identification information’ is acquired (step SP20-4). The acquired ‘user authorization information’, ‘user identification information’ and ‘monetary information’ are sent to the server device (step SP20-5), and then, the first processing finishes.

After this, the collective suspension processing server device (i.e. the collective suspension representation processing server device) 20, which works as the server device, or the server device 20a starts the first processing. The ‘user authorization information’, the ‘user identification information’ and the ‘monetary information’ are received from the user terminal device 10 or the terminal device 10a (step SP20-6). The received ‘user authorization information’, ‘user identification information’ and ‘monetary information’ are encrypted using the common encryption key (step SP20-7). The server device uses the encrypted ‘user authorization information’, ‘user identification information’ and ‘monetary information’ for searching the information related to the ‘user authorization information’, the ‘user identification information’ and the ‘monetary information’ encrypted using the common key and stored in the predetermined storage unit. Then, the server device acquires the encrypted ‘user authorization information’ of the related information from among the searched encrypted information (step SP20-8). Furthermore, the server device finds out the electronic mail address from among the information related to the encrypted ‘user authorization information’, decrypts only the electronic mail address and sends the ‘collective suspension processing confirmation notification’ to the terminal device (step SP20-9). Then, the first processing finishes.

After this, the second processing of the user terminal device 10 or the terminal device 10a starts. The ‘collective suspension processing confirmation notification’, which is sent from the collective suspension processing server device (i.e. the collective suspension representation processing server device) 20, is received and displayed on the predetermined display unit (step SP20-10). When the authorization processing is executed by the user based on the contents displayed on the display unit, the second decryption key is acquired from the predetermined storage unit (step SP20-11). The set of the ‘second decryption key’, the ‘user authorization information’, ‘the user identification information’ and the encrypted ‘monetary information for settlement processing’ is sent to the server device (step SP20-12), and then, the second processing finishes.

After this, the second processing of the collective suspension processing server device (i.e. the collective suspension representation processing server device) 20 or the server device 20a starts. The server device receives the set of the ‘second decryption key’, the ‘user authorization information’, the ‘user identification information’ and the encrypted ‘monetary information for settlement processing’ from the user terminal device 10 or the terminal device 10a (step SP20-13). The received ‘user authorization information’ and the ‘user identification information’ are encrypted by using the common encryption key (step SP20-14). Then, by using these encrypted ‘user authorization information’ and the ‘user identification information’, the information completely identical to the encrypted ‘user authorization information’ and ‘user identification information’ stored in the storage unit are searched (SP20-15). If the information related to the encrypted ‘user authorization information’ and the ‘user identification information’ can be searched, the information is decrypted using the common decryption key (step SP20-16). Then, the first decryption key is generated using the information related to the decrypted ‘user authorization information’ and the ‘user identification information’ (step SP20-17). The ‘third decryption key’ is automatically generated using the ‘second decryption key’ received from the user terminal device and the ‘first decryption key’ (step SP20-18). By using the generated ‘third decryption key’, the previously received encrypted ‘monetary information for settlement processing’ in connection with the collective suspension processing is decrypted (step SP20-19). The decrypted ‘monetary facilities information in connection with the collective suspension’ is sent to the monetary facilities based on the each of the monetary facility information (step SP20-20). Then, the second processing finishes.

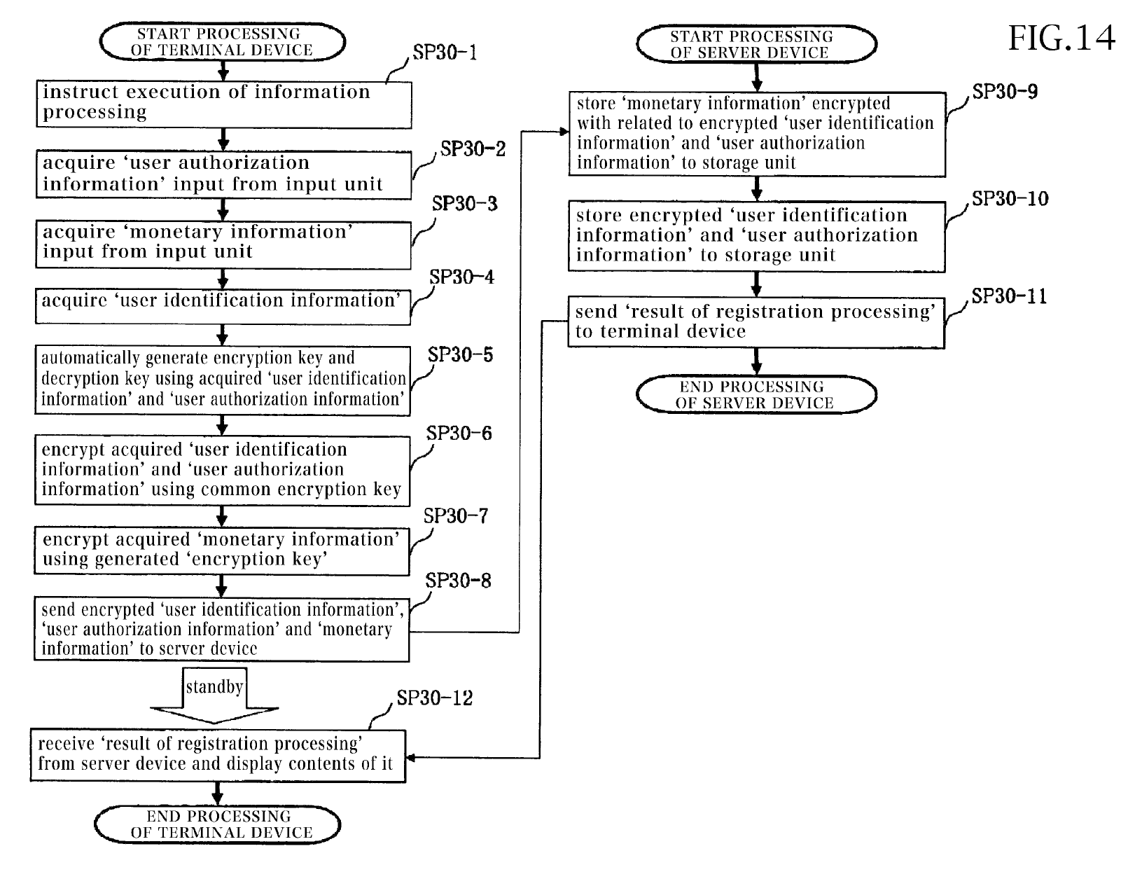

FIG. 14 is a diagram showing the flowchart of information registration of the collective suspension processing system according to the present embodiment. As shown in the FIG. 14, if the processing of the user terminal device 10, which works as the terminal device, or the terminal device 10a starts, the execution of the information processing is instructed (step SP30-1). Then, the ‘user authorization information’ input from the predetermined input unit is acquired (step SP30-2). The ‘monetary information’ input from the input unit is acquired (step SP30-3). The ‘user identification information’ is acquired (step SP30-4). Then, the encryption key and the decryption key are automatically generated using the acquired ‘user identification information’ and ‘user authorization information’ (step S030-5). Furthermore, the acquired ‘user identification information’ and ‘user authorization information’ are encrypted using the common encryption key (step SP30-6). The acquired ‘monetary information’ is encrypted using the generated ‘encryption key’ (step SP30-7). The encrypted ‘user identification information’, ‘user authorization information’ and ‘monetary information’ are sent to the server device (step SP30-8). Then, the terminal device turns into the standby state.

After this, the processing of the collective suspension processing server device (i.e. the collective suspension representation processing server device) 20, which works as server device, or the server device 20a starts. The ‘monetary information’, which is encrypted with being related to the encrypted ‘user identification information’ and ‘use authorization information’, is stored into the predetermined storage unit (step SP30-9). The encrypted ‘user identification information’ and ‘user authorization information’ are stored into the storage unit (step SP30-10). The ‘result of the registration processing’ is sent to the user terminal device 10 or the terminal device 10a (step SP30-11), and then, the processing of the server device finishes.

Then, the user terminal device 10 or the terminal device 10a returns from the standby state, and receives the ‘result of the registration processing’ from the collective suspension processing server device (i.e. the collective suspension representation processing server device) 20 or the server device 20a. The user terminal displays the contents of the ‘result of the registration processing’ onto the predetermined display unit (step SP30-12), and then, the processing of the server device finishes.

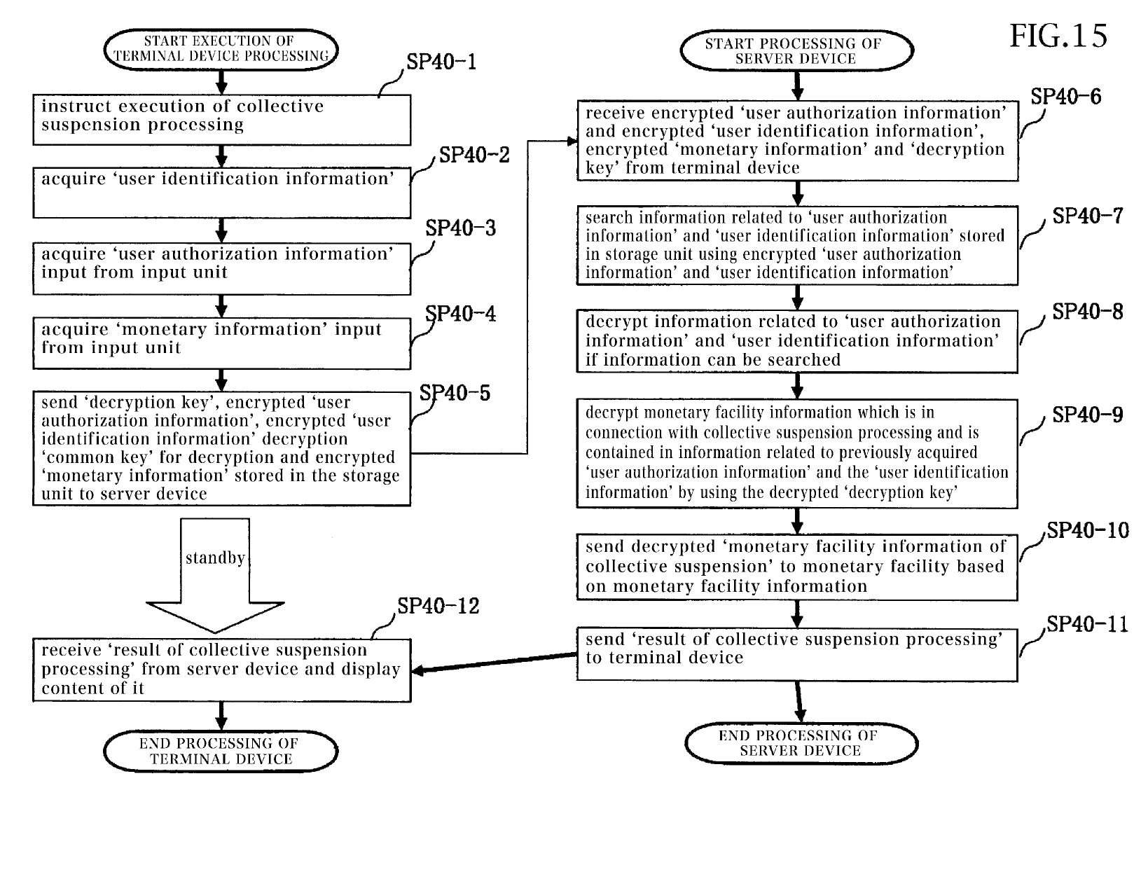

FIG. 15 is the diagram showing the flowchart of the collective suspension processing according to the present embodiment. As shown in FIG. 15, if the processing of the user terminal device 10, which works as the terminal device, or the terminal device 10a starts, the execution of the collective suspension processing is instructed (step SP40-1). Then, the ‘user identification information’ is acquired (step SP40-2). The ‘user authorization information’ input from the predetermined input unit is acquired (step SP40-3). The ‘monetary information’ input from the input unit is acquired (step SP40-4). Then, the terminal device sends the ‘decryption key’, the encrypted ‘user authorization information’, the encrypted ‘user identification information’ the decryption ‘common key’ for decryption and the encrypted ‘monetary information’, each of which are stored in the storage unit, to the collective suspension processing server device (i.e. the collective suspension representation processing server device) 20 or the server device 20a (step SP40-5). Then, the terminal device turns to the standby state.

After this, the processing of the collective suspension processing server device (i.e. the collective suspension representation processing server device) 20, which works as a server device, or the server device 20a starts. Then, the encrypted ‘user authorization information’, the encrypted ‘user identification information’, the encrypted ‘monetary information’ and the ‘decryption key’ are received from the user terminal device 10, which works as the terminal device, or the terminal device 10a. The server device searches the information related to the ‘user authorization information’ and the ‘user identification information’ encrypted and stored in the predetermined storage unit using the encrypted ‘user authorization information’ and the encrypted ‘user identification information’ (step SP40-7). If the information related to ‘user authorization information’ and the ‘user identification information’ can be searched, the server device decrypts the information using the common key (step SP40-8). By using the decrypted ‘decryption key’, the server device decrypts the monetary facility information which is in connection with the collective suspension processing and is contained in the information related to the previously acquired ‘user authorization information’ and the ‘user identification information’ (step SP40-9). The decrypted ‘monetary facility information in connection with collective suspension’ is sent to the predetermined monetary facilities based on the each of the monetary facility information (step SP40-10). Then, the ‘result of the collective suspension processing’ is sent to the terminal device (step SP40-11), and then, the processing of the server device finishes.

Then, the user terminal device 10 or the terminal device 10a returns from the standby state, and receives the ‘result of the collective suspension processing’ from the collective suspension processing server device (i.e. the collective suspension representation processing server device) 20 or the server device 20a. The terminal device displays the contents of the received ‘result of the collective suspension processing’ onto the predetermined display unit (step SP40-12). Then, the processing of the terminal device finishes.

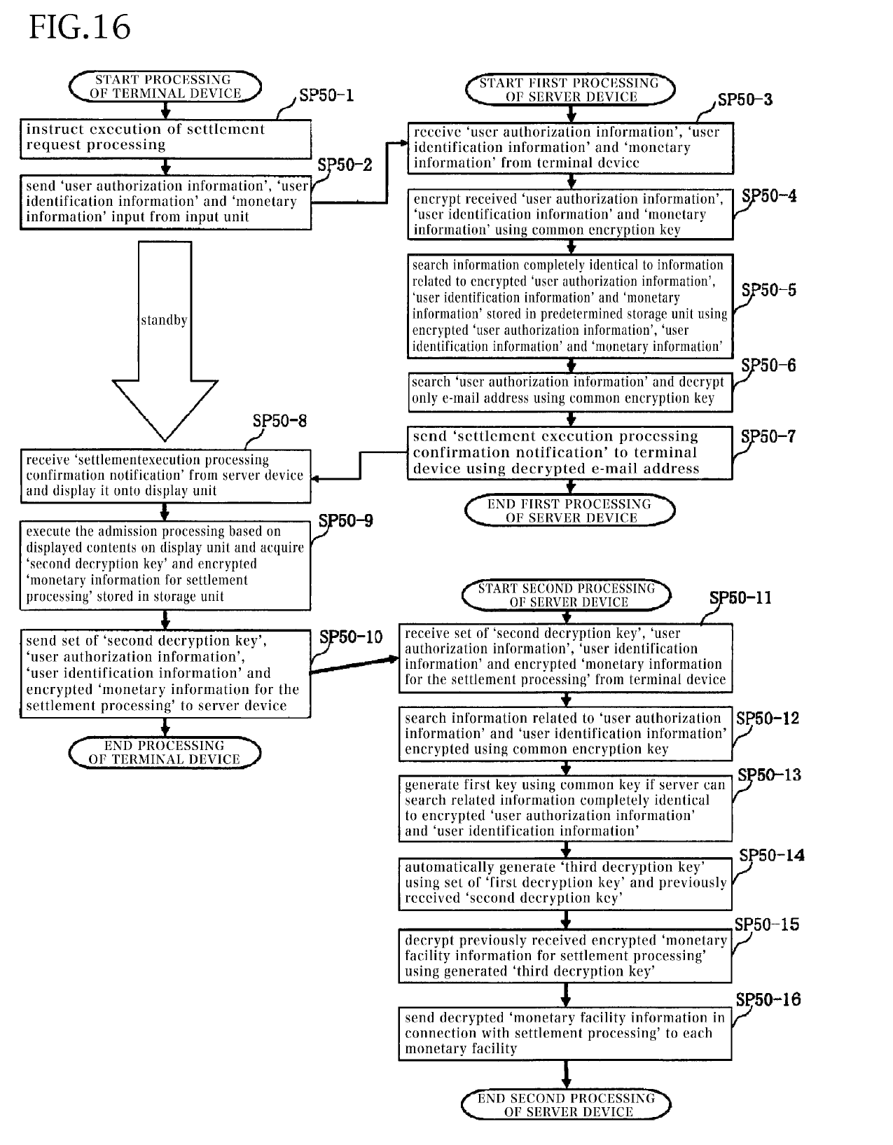

FIG. 16 is the diagram showing the flowchart of settlement representation processing according to the present embodiment. As shown in FIG. 16, if the processing of the terminal device 10a, which works as the terminal device, starts, the execution of the settlement request processing is instructed (step SP50-1). Then, the ‘user authorization information’, the ‘user identification information’ and the ‘monetary information’ input from the predetermined input unit are sent to the server device 20a which works as the server device (step SP50-2). After this, the terminal device turns to the standby state.

Then, the first processing of the server device 20a, which works as the server device, starts and the ‘user authorization information’, the ‘user identification information’ and the ‘monetary information’ are received from the terminal device (step SP50-3). The received ‘user authorization information’, the ‘user identification information’ and the ‘monetary information’ are encrypted using the common encryption key (step SP50-4). By using the encrypted ‘user authorization information’, ‘user identification information’ and ‘monetary information’, the server device searches the information completely identical to the information related to the encrypted ‘user authorization information’, ‘user identification information’ and ‘monetary information’ stored in the predetermined storage unit (step SP50-5). In addition, the server device searches the ‘user authorization information’ and decrypts only the electronic mail address of it using the common encryption key (step SP50-6). With using the decrypted electronic mail address, the ‘settlement execution processing confirmation notification’ is sent to the terminal device 10a which works as the terminal device (step SP50-7). Then, the first processing finishes.

After this, the terminal device 10a executes the processing of receiving the ‘settlement execution processing confirmation notification’ sent from the server device, and displaying it onto the predetermined display unit (step SP50-8). If the authorization processing is performed based on the contents displayed on the display unit, the terminal device acquires the ‘second decryption key’ and the encrypted ‘monetary information for the settlement processing’ from the predetermined storage unit (step SP50-9). Moreover, the terminal device sends the set of the ‘second decryption key’, the ‘user authorization information’, the ‘user identification information’ and the encrypted ‘monetary information for the settlement processing’ to the server device 20a (step SP50-10). Then, the processing finishes.

After this, the server device 20a starts the second processing, then, the set of the ‘second decryption key’, the ‘user authorization information’, the ‘user identification information’ and the encrypted ‘monetary information for the settlement processing’ are received from the terminal device (step SP50-11). Next, by using the ‘user authorization information’ and the ‘user identification information’ encrypted using the common encryption key, the server device searches the information completely identical and related to the encrypted ‘user authorization information’ and ‘user identification information’ stored in the storage unit (step SP50-12). If the server can search the information related to the encrypted ‘user authorization information’ and ‘user identification information’, the first key is generated using the common key (step SP50-13). Then, the ‘third decryption key’ is automatically generated using the set of the ‘first decryption key’ and the previously received ‘second decryption key’ (step SP50-14). The encrypted ‘monetary information for the settlement processing’, which is previously received, is decrypted by using the generated ‘third decryption key’ (step SP50-15). The decrypted ‘monetary information in connection with the settlement processing’ is sent to the predetermined monetary facilities based on the each of the monetary facility information (step SP50-16). Then, the second processing finishes.

The present embodiment can provide the settlement system which notifies the settlement confirmation information to the user and executes the settlement based on the admission of the user when the order of purchasing the product is performed using the card information of the registered user, hence, provides the safe settlement to the user.

In addition, the user can encrypt and manage only the specified portion need to be encrypted. Therefore, the encryption amount of the information can be reduced.

Incidentally, the present invention is not limited to the above described embodiment, and can be realized with any kinds of modifications within the range of not extending the object of the present invention. Moreover, the above described embodiment is only an example for realizing the technical idea according to the present application, and there are other embodiments which can be applied to the technical idea according to the present application.

The value of the present invention does not reduce even when the device, the method or the system generated by using the present invention is provided to the secondary products to be commercialized.

### POSSIBILITY OF THE INDUSTRIAL UTILIZATION

The system and the method of the information management according to the present invention can store and manage the user's associated information in safety with improving the user's usability, and so the present invention can be utilized and has high usefulness not only for the information industry, but for all of other industries such as the construction industry, the restaurant business, various kinds of the manufacturing and the distributive trade.

What is claimed is:

1. A terminal device connected to the collective suspension processing server device, comprising:
a common key processing unit which generates a common encryption key used for encryption and a common decryption key used for decryption, by using an input unit which executes an input operation for inputting an electronic information based on a user's operation of the terminal device, a storage unit which stores the electronic information, a display unit which displays the electronic information, a reception unit which receives the electronic information, a user authorization information input from the input unit based on the user's input operation and a user identification information received from the storage unit,
a key generation processing unit which receives identification information stored in the storage unit in addition to the user authorization information input from the input unit based on the user's input operation and the monetary information corresponding to the information of the bank account and credit card owned by the user, and automatically generates a pair of the encryption key for encryption and the decryption key for decryption based on the monetary information, the authorization information and the identification information,
an encryption processing unit which receives letters and numerals used for an encryption from the common key processing unit when the user authorization information for registration is input from the input unit, generates the encrypted sequence of letters and numerals so that the order of source sequence is not mixed up and the number of letters and numerals is equal to or less than quintuple of the source sequence by putting letters and numerals of common encryption key into a sequence of letters and numerals of the user authorization information, acquires the user identification information from the storage unit of the terminal device, and generates the encrypted sequence of letters and numerals so that the order of source sequence is not mixed up and the number of letters and numerals is equal to or less than quintuple of the source sequence by putting letters and numerals of common encryption key into a sequence of letters and numerals of the user identification information,
a storage unit which stores the encrypted authorization information and the encrypted identification information generated by the encryption processing unit of the terminal device, a decryption common key information for decrypting the encrypted authorization information and the encrypted identification information, the decryption key generated by the key generation processing unit, the encrypted monetary information, the encrypted authorization information and the encrypted identification information with relating each other,
a transmission unit which transmits a decryption common key information for decrypting the encrypted authorization information and the encrypted identification information stored in the storage unit of the terminal device, the decryption key generated by the key generation processing unit, the encrypted monetary information, encrypted authorization information and the encrypted identification information,
a storage unit which stores an electronic information transmitted from the terminal device to the collective suspension processing server device,
a decryption processing unit which reads the encrypted monetary information and the decryption key stored in the storage unit of the terminal device, and decrypts the monetary information,
a reception unit which receives the decryption common key information for decrypting the encrypted authorization information and the encrypted identification information related to the selected monetary information, the decryption key generated by the key generation processing unit, the encrypted monetary information, the encrypted authorization information and the encryption identification information, when the monetary information desired to be suspended is selected from among the decrypted monetary information displayed on the display unit of the terminal device, and the decryption common key information, the decryption key, the encrypted monetary information, the encrypted authorization information and the encrypted identification information are acquired from the storage unit and sent to the collective suspension processing server device,
an authorization unit which confirms whether the received encrypted authorization information is registered,
an encryption processing unit which checks the existence or nonexistence of an information completely identical to the encrypted sequence of letters and numerals of the encrypted authorization information and the encrypted identification information registered in the storage unit of the collective suspension processing server device, based on the encrypted sequence of letters and numerals of the encrypted authorization information and the encrypted identification information received from the terminal device,
a decryption processing unit which decrypts the encrypted authorization information and the encrypted identification information completely identical to the encrypted sequence of letters and numerals, the encrypted monetary information received from the terminal device and the decryption key for decryption, by using the decryption common key,
a transmission unit which transmits a monetary information outgoing command for suspension to the specified monetary facilities received from the terminal device.

2. A collective suspension processing method of a terminal device connected to the collective suspension processing server device, comprising:
a common key processing step which generates a common encryption key used for encryption and a common decryption key used for decryption, by using an input unit which executes an input operation for inputting an electronic information based on a user's operation of the terminal device, a storage unit which stores the electronic information, a display unit which displays the electronic information, a reception unit which receives the electronic information, a user authorization information input from the input unit based on the user's input operation and a user identification information received from the storage unit,
a key generation processing step which receives identification information for identifying the user stored in the storage unit in addition to the user authorization information input from the input unit based on the user's input operation and the monetary information corresponding to the information of the bank account and credit card owned by the user, and automatically generates a pair of the encryption key for encryption and the decryption key for decryption based on the monetary information, the authorization information and the identification information,
an encryption processing step which receives letters and numerals used for an encryption from the common key processing unit when the user authorization information for registration is input from the input unit, generates the encrypted sequence of letters and numerals so that the order of source sequence is not mixed up and the number of letters and numerals is equal to or less than quintuple of the source sequence by putting letters and numerals of common encryption key into a sequence of letters and numerals of the user authorization information, acquires the user identification information from the storage unit of the terminal device, and generates the encrypted sequence of letters and numerals so that the order of source sequence is not mixed up and the number of letters and numerals is equal to or less than quintuple of the source sequence by putting letters and numerals of common encryption key into a sequence of letters and numerals of the user identification information,
a storage step which stores the encrypted authorization information and the encrypted identification information generated by the encryption processing unit of the terminal device, a decryption common key information for decrypting the encrypted authorization information and the encrypted identification information, the decryption key generated by the key generation processing unit, the encrypted monetary information, the encrypted authorization information and the encrypted identification information with relating each other,
a transmission step which transmits a decryption common key information for decrypting the encrypted authorization information and the encrypted identification information stored in the storage unit of the terminal device, the decryption key generated by the key generation processing unit, the encrypted monetary information, encrypted authorization information and the encrypted identification information,
a storage step which stores an electronic information transmitted from the terminal device to the collective suspension processing server device,
a decryption processing step which reads the encrypted monetary information and the decryption key stored in the storage unit of the terminal device, and decrypts the monetary information,
a receiving step which receives the decryption common key information for decrypting the encrypted authorization information and the encrypted identification information related to the selected monetary information, the decryption key generated by the key generation processing unit, the encrypted monetary information, the encrypted authorization information and the encrypted identification information, when the monetary information desired to be suspended is selected from among the decrypted monetary information displayed on the display unit of the terminal device, and the decryption common key information, the decryption key, the encrypted monetary information, the encrypted authorization information and the encrypted identification information are acquired from the storage unit and sent to the collective suspension processing server device,
an authorization step which confirms whether the received encrypted authorization information is registered,
an encryption processing step which checks the existence or nonexistence of an information completely identical to the encrypted sequence of letters and numerals of the encrypted authorization information and the encrypted identification information registered in the storage unit of the collective suspension processing server device, based on the encrypted sequence of letters and numerals of the encrypted authorization information and the encrypted identification information received from the terminal device,
a decryption processing step which decrypts the encrypted authorization information and the encrypted identification information completely identical to the encrypted sequence of letters and numerals, the encrypted monetary information received from the terminal device and the decryption key for decryption, by using the decryption common key,
a transmission step which transmits a monetary information outgoing command for suspension to the specified monetary facilities received from the terminal device.

3. A monetary account suspension processing system comprising:
the collective suspension representation processing server device according to claim 1,
a monetary facility server device which executes a processing for receiving an information related to the user, an encrypted monetary information for suspension and the decryption key from the terminal device, and for suspending an usage of the encrypted monetary information.

4. The collective suspension processing server device according to claim 1, comprising a monetary facility server device for suspending a use of the encrypted monetary information.

5. A server device connected to a terminal device via a network, comprising:
a common key processing unit which acquires a user authorization information and a user monetary information for registration input by a user's input operation from an input unit of the terminal device and an identification information for identifying a user stored in the storage unit of the terminal device, and provides letters and numerals used for an encryption of the user authorization information and the user identification information, those are sent from a transmission unit of the terminal device and received by the collective suspension representation processing server device, by each field unit,
an encryption unit which generates an encrypted authorization information and an encrypted identification information, each of information has an encrypted sequence of letters and numerals, so that the order of source sequence is not mixed up and the number of letters and numerals is equal to or less than quintuple of the source sequence by putting letters and numerals of common encryption key into a sequence of letters and numerals of the information,
a key generation processing unit which dynamically generates a first key using the encrypted authorization information and the encrypted identification information encrypted by the encryption processing unit, dynamically generates a second key using random numerals and letters received from the key generation processing unit of the collective suspension representation processing server device, dynamically generates a third key using the first and second keys and generates an encrypted monetary information for settlement processing using the user monetary information and the third key,
a transmission unit which transmits the second key and the encrypted monetary information for settlement processing generated by the key generation processing unit from the transmission unit of the collective suspension representation processing server device to the terminal device,
a storage unit of the terminal device which stores a received information,
a decryption processing unit which;
acquires the monetary information for encryption processing, the authorization information and the identification information to be suspended based on a monetary information outgoing command operation corresponding to suspension using a display unit of the terminal device, sending them from a transmission unit of the terminal device,
generates an encrypted sequence of letters and numerals so that the order of source sequence is not mixed up and the number of letters and numerals is equal to or less than quintuple of the source sequence by putting letters and numerals for encrypting by each field unit into a sequence of letters and numerals of the information by the encryption processing unit of the collective suspension representation processing server device,
generates a first key for reading out and decrypting the encrypted authorization information and the encrypted identification information completely identical to the encrypted sequence of letters and numerals of the encrypted authorization and the encrypted identification information stored in the storage unit, and
decrypts the encrypted authorization information and the encrypted identification information,
a key generation processing unit which generates a third key using a first key generated by the decryption processing unit for decryption and a second key sent from the terminal device,
a decryption processing unit which decrypts an encrypted monetary information for settlement processing using the third key,
a transmission unit which transmits a monetary information outgoing command for suspension to the monetary facility.

6. A server device connected to a terminal device via a network, comprising:
a common key processing step which acquires a user authorization information and a user monetary information for registration input by a user's input operation from an input unit of the terminal device and an identification information for identifying a user stored in the storage unit of the terminal device, and provides letters and numerals used for an encryption of the user authorization information and the user identification information, those are sent from a transmission unit of the terminal device and received by the reception unit of the collective suspension representation processing server device, by each field unit,
an encryption step which generates an encrypted authorization information and an encrypted identification information, each of information has an encrypted sequence of letters and numerals, so that the order of source sequence is not mixed up and the number of letters and numerals is equal to or less than quintuple of the source sequence by putting letters and numerals of common encryption key into a sequence of letters and numerals of the information,
a key generation processing step which dynamically generates a first key using the encrypted authorization information and the encrypted identification information encrypted by the encryption processing unit, dynamically generates a second key using random numerals and letters by the key generation processing unit of the collective suspension representation processing server device, dynamically generates a third key using the first and second keys and generates an encrypted monetary information for settlement processing using the user monetary information and the third key,
a transmission step which transmits the second key and the encrypted monetary information for settlement processing generated by the key generation processing unit from the transmission unit of the collective suspension representation processing server device to the terminal device,
a storage unit of the terminal device which stores a received information,
a decryption processing step which;
acquires the monetary information for encryption processing, the authorization information and the identification information to be suspended based on a monetary information outgoing command operation corresponding to suspension using a display unit of the terminal device, sending them from a transmission unit of the terminal device,
generates an encrypted sequence of letters and numerals so that the order of source sequence is not mixed up and the number of letters and numerals is equal to or less than quintuple of the source sequence by putting letters and numerals for encrypting by each field unit into a sequence of letters and numerals of the information by the encryption processing unit of the collective suspension representation processing server device,
generates a first key for reading out and decrypting the encrypted authorization information and the encrypted identification information completely identical to the encrypted sequence of letters and numerals of the encrypted authorization and the encrypted identification information stored in the storage unit, and
decrypts the encrypted authorization information and the encrypted identification information,
a key generation processing step which generates a third key using a first key generated by the decryption processing unit for decryption and a second key sent from the terminal device,
a decryption processing step which decrypts an encrypted monetary information for settlement processing using the third key,
a transmission step which transmits a monetary information outgoing command for the suspension to the monetary facility.

7. A server device connected to a terminal device via a network, comprising:
a common key processing unit which acquires a user authorization information and a user credit card information for registration input from an input unit of the terminal device based on a user's input operation, an identification information for identifying the user, the authorization information and the user credit card information stored in a storage unit of the terminal device, each information is sent from a transmission unit of the terminal device, and provides letters and numerals for encrypting the user authorization information and the user identification information received in the settlement representation processing server device by each field unit,
an encryption processing unit which generates an encrypted authorization information and an encrypted identification information, each of information has an encrypted sequence of letters and numerals so that the order of source sequence is not mixed up and the number of letters and numerals is equal to or less than quintuple of the source sequence by putting letters and numerals of common encryption key into a sequence of letters and numerals of the information,
a key generation processing unit which dynamically generates a first key using the encrypted authorization information and the encrypted identification information encrypted by the encryption processing unit, dynamically generates a second key using random numerals and letters received from the key generation processing unit of the collective suspension representation processing server device, dynamically generates a third key using the first and second keys and generates an encrypted monetary information for settlement processing using the user credit card information and the third key,
a transmission unit which transmits the second key and the encrypted user credit card information for settlement processing generated by the key generation processing unit from the transmission unit of the collective suspension representation processing server device to the terminal device,
a storage unit of the terminal device which stores the received information,
a transmission unit which reads out the user authorization information, the user identification information and the user credit card information, and transmits them to the reception unit of the settlement representation processing server, when an operation for requesting a product desired to be purchased is executed using the input unit of the terminal device,
a decryption processing unit which;
being provided with letters and numerals for encrypting a user authorization information and a user identification information received by the reception unit of the settlement representation processing server device by each field unit,
searches information from among the encrypted authorization information and the encrypted identification information stored as the information for registration in the storage unit of the settlement representation processing server device, the searched information are completely identical to the encrypted authorization information and the encrypted identification information generated by an encryption processing unit,
decrypts only an electronic mail address contained in the encrypted authorization information stored by each field unit and makes a transmission unit to send a settlement execution processing confirmation notification toward the decrypted electronic mail address,
makes a display unit of the terminal device to display the settlement execution processing confirmation notification received by a reception unit of the terminal device,
makes the terminal device to acquire an encrypted credit card information for settlement processing, an authorization information, an identification information and a second key from the storage unit of the terminal device and send them using a transmission unit of the terminal device, when a confirming processing request operation is executed based on the contents displayed on the display unit,
makes the encryption processing unit to generate the encrypted sequences of letters and numerals so that the order of source sequence is not mixed up and the number of letters and numerals is equal to or less than quintuple of the source sequence by putting letters and numerals for encrypting by each field unit into a sequence of letters and numerals of the user authorization information and the user identification information received by the settlement representation processing server device,
reads out the encrypted authorization information and the encrypted identification information completely identical to the encrypted sequence of letters and numerals of the encrypted authorization information and the encrypted identification information stored in the storage unit, and generates a first key for decryption,
a key generation processing unit which generates a third key using a first key generated by the decryption processing unit for decryption and a second key sent from the terminal device,
a decryption processing unit which decrypts the encrypted credit card information for settlement processing sent from the terminal device using the third key,
a transmission unit which transmits the credit card information to a monetary facility to execute a settlement processing with a monetary information.

8. A settlement representation processing method using server device connected to a terminal device via a network, comprising:
a common key processing step which acquires a user authorization information and a user credit card information for registration input from an input unit of the terminal device based on a user's input operation, an identification information for identifying the user, the authorization information and the user credit card information stored in a storage unit of the terminal device, each information is sent from a transmission unit of the terminal device, and provides letters and numerals for encrypting the user authorization information and the user identification information received by the reception unit of the settlement representation processing server device by each field unit,
an encryption processing step which generates an encrypted authorization information and an encrypted identification information, each of information has an encrypted sequence of letters and numerals so that the order of source sequence is not mixed up and the number of letters and numerals is equal to or less than quintuple of the source sequence by putting letters and numerals of common encryption key into a sequence of letters and numerals of the information,
a key generation processing step which dynamically generates a first key using the encrypted authorization information and the encrypted identification information encrypted by the encryption processing unit, dynamically generates a second key using random numerals and letters received from the key generation processing unit of the collective suspension representation processing server device, dynamically generates a third key using the first and second keys and generates an encrypted credit card information for settlement processing using the user credit card information and the third key,
a transmission step which transmits the second key and the encrypted user credit card information for settlement processing generated by the key generation processing unit from the transmission unit of the collective suspension representation processing server device to the terminal device,
a storage step of the terminal device which stores the received information,
a transmission step which reads out the user authorization information, the user identification information and the user credit card information, and transmits them to the reception unit of the settlement representation processing server, when an operation for requesting a product desired to be purchased is executed using the input unit of the terminal device,
a decryption processing step which;
being provided with letters and numerals for encrypting a user authorization information and a user identification information received by the reception unit of the settlement representation processing server device by each field unit,
searches information from among the encrypted authorization information and the encrypted identification information stored as the information for registration in the storage unit of the settlement representation processing server device, the searched information are completely identical to the encrypted authorization information and the encrypted identification information generated by an encryption processing unit,
decrypts only an electronic mail address contained in the encrypted authorization information stored by each field unit and makes a transmission unit to send a settlement execution processing confirmation notification toward the decrypted electronic mail address,
makes a display unit of the terminal device to display the settlement execution processing confirmation notification received by a reception unit of the terminal device,
makes the terminal device to acquire an encrypted credit card information for settlement processing, an authorization information, an identification information and a second key from the storage unit of the terminal device and send them using a transmission unit of the terminal device, when a confirming processing request operation is executed based on the contents displayed on the display unit,
makes the encryption processing unit to generate encrypted sequences of letters and numerals so that the order of source sequence is not mixed up and the number of letters and numerals is equal to or less than quintuple of the source sequence by putting letters and numerals for encrypting by each field unit into a sequence of letters and numerals of the user authorization information and the user identification information received by the settlement representation processing server device,
reads out the encrypted authorization information and the encrypted identification information completely identical to the encrypted sequence of letters and numerals to the encrypted authorization information and the encrypted identification information stored in the storage unit, and generates a first key for decryption,
makes the encryption processing unit to generate the encrypted sequences of letters and numerals so that the order of source sequence is not mixed up and the number of letters and numerals is equal to or less than quintuple of the source sequence by putting letters and numerals for encrypting by each field unit into a sequence of letters and numerals of the user authorization information and the user identification information received by the settlement representation processing server device,
reads out the encrypted authorization information and the encrypted identification information completely identical to the encrypted sequence of letters and numerals to the encrypted authorization information and the encrypted identification information stored in the storage unit, and decrypt them,
a key generation processing step which generates a third key using a first key generated by the decryption processing unit for decryption and a second key sent from the terminal device,
a decryption processing step which decrypts the encrypted credit card information for settlement processing sent from the terminal device using the third key,
a transmission step which transmits the credit card information to a monetary facility to execute a settlement processing with a monetary information.

9. The monetary facility settlement processing system according to claim 7, comprising a server device which receives the settlement request processing information, the decryption key, the identification information and the authorization information from the terminal device and executes a settlement request processing.

10. A settlement request information providing device in which a terminal device and a settlement representation processing server device are connected via Internet, comprising:
a reception unit which receives a user authorization information and a user credit card information for registration input from an input unit of the terminal device based on a user's input operation, an identification information for identifying the user stored in a storage unit of the terminal device, transmitted from a transmission unit toward the settlement representation processing server device,
a common key processing unit which provides letters and numerals for encrypting the user authorization information, user identification information and the credit card information received by the reception unit, by each field unit,
an encryption processing unit which generates an encrypted authorization information, an encrypted identification information and an encrypted credit card information, each of information has an encrypted sequence of letters and numerals that the order of source sequence is not mixed up and the number of letters and numerals is equal to or less than quintuple of the source sequence, by putting letters and numerals of common encryption key into a sequence of letters and numerals of the information,
an encryption processing unit which makes the common key processing unit to generate letters and numerals for encrypting the credit card information and the authorization information by each field unit, and dynamically generates encrypted sequence of letters and numerals of an encrypted credit card information and an encrypted authorization information so that the order of source sequence is not mixed up and the number of letters and numerals is equal to or less than quintuple of the source sequence, by putting the letters and numerals into the credit card information and the authorization information,
a control processing unit which checks whether the encrypted credit card information stored in the storage unit of the settlement representation processing server device and the encrypted sequence of letters and numerals of the encrypted authorization information are completely identical, and stops the processing if they are not identical,
a transmission unit which transmits a settlement processing suspension command to the product settlement request information providing device of external.

11. A settlement request information providing method of a device in which a terminal device and a settlement representation processing server device are connected via Internet, comprising:
a receiving step which receives a user authorization information and a user credit card information for registration input from an input unit of the terminal device based on a user's input operation, an identification information for identifying the user stored in a storage unit of the terminal device, transmitted from a transmission unit toward the settlement representation processing server device,
a common key processing step which provides letters and numerals for encrypting the user authorization information, user identification information and the credit card information received by the reception unit, by each field unit,
an encryption processing step which generates an encrypted authorization information, an encrypted identification information and an encrypted credit card information, each of information has an encrypted sequence of letters and numerals that the order of source sequence is not mixed up and the number of letters and numerals is equal to or less than quintuple of the source sequence, by putting letters and numerals of common encryption key into a sequence of letters and numerals of the information,
an encryption processing step which makes the common key processing unit to generate letters and numerals for encrypting the credit card information and the authorization information by each field unit, and dynamically generates the encrypted sequence of letters and numerals of an encrypted credit card information and an encrypted authorization information so that the order of source sequence is not mixed up and the number of letters and numerals is equal to or less than quintuple of the source sequence, by putting the letters and numerals into the credit card information and the authorization information,
a control processing step which checks whether the encrypted credit card information stored in the storage unit of the settlement representation processing server device and the encrypted sequence of letters and numerals of the encrypted authorization information are completely identical, and stops the processing if they are not identical,
a transmission step which transmits a settlement processing suspension command to the product settlement request information providing device of external.

12. The settlement request information providing device according to claim 10, comprises a monetary facility server device which executes a credit card settlement.

13. The settlement request information providing device according to claim 10, wherein;
the transaction unit of the settlement representation processing server device transmits the encrypted monetary information,
the monetary facility server device receives the encrypted monetary information via the network,
the transmission unit of the user terminal device transmits the second key for decrypting the encrypted monetary information and the encrypted monetary information for settlement processing directly to the monetary facility server device, and
the monetary facility server executes the settlement processing.
